(19) United States
(12) Patent Application Publication
(10) Pub. No.: US 2012/0246470 A1
(43) Pub. Date: Sep. 27, 2012

(54) INFORMATION PROCESSING DEVICE, INFORMATION PROCESSING SYSTEM, SOFTWARE ROUTINE EXECUTION METHOD, AND REMOTE ATTESTATION METHOD

(76) Inventors: Kenneth Alexander Nicolson, Hyogo (JP); Hideki Matsushima, Osaka (JP); Manabu Maeda, Osaka (JP); Tomoyuki Haga, Nara (JP)

(21) Appl. No.: 13/514,481

(22) PCT Filed: Jan. 27, 2011
(86) PCT No.: PCT/JP2011/000448

§ 371 Date: Jun. 7, 2012

(51) Int. Cl. H04L 29/06

(52) U.S. Cl. 713/158; 713/155

(57) ABSTRACT

Techniques for protecting memory locations within a stakeholder's engine according to the Multi-Stakeholder Model, and a protocol for remote attestation to a device supporting the Multi-Stakeholder Model that provides extra evidence of the identity of the three actors.

### TECHNICAL FIELD

The present invention relates to an information processing device, information processing system, and software routine execution method which check integrity of data, and to a remote attestation method of performing remote attestation between devices.

### BACKGROUND ART

For safeguarding electronic devices such as personal computers, mobile phones, etc, whilst maintaining openness and flexibility, the Trusted Computing Group (TCG) has been created. The Trusted Computing Group is focused on the specification of key aspects of an overall security solution, in particular a hardware computer chip called a Trusted Platform Module (TPM) as described in TPM Main Part 1 Design Principals, Specification Version 1.2, Revision 103 (NPL1), also published as ISO/IEC standard 11889. The Trusted Platform Module is a hardware device that provides amongst other features cryptographically secure storage of information, a set of cryptographic operations performed in a secured environment, and a set of integrity metrics.

Furthermore, a TCG working group, the Mobile Phone Working Group (MPWG) has described in TCG Mobile Reference Architecture version 1.0 12 Jun. 2007 (NPL 2) and TCG Mobile Trusted Module Specification version 1.0 12 Jun. 2007 (NPL 3) enhancements to the TPM targeted towards devices such as mobile phones, specifying instead of a hardware TPM a Mobile Trusted Modules (MTM) that may be realised in either software or hardware.

Furthermore, another TCG working group, the Virtualized Platform Working Group (VPWG) has described how a TPM may be supported within a virtualized platform.

The mobile-related documents have been thoroughly reviewed to ensure that trust and security is maintained throughout the device's lifetime, so provide a useful baseline for those wanting to implement a secure device. The virtualization-related documents have also been reviewed to ensure that trust and security is maintained throughout the virtualization process, so provide a useful baseline for those wanting to implement a device that can provide virtualization securely.

One feature of the Mobile Reference Architecture is the Multi-Stakeholder Model (MSM), a specification for how a number of interested parties (stakeholders) may each independently develop their own Mobile Trusted Module and surrounding services—this set of MTM plus associated services is known as an Engine—and install them onto a single device. For instance, the Device Manufacturer has an engine that controls all the basic hardware within the system by using its MTM to ensure the trust and security. Next, a Carrier Engine provides MTM-secured higher-level connectivity services, an Operator Engine provides MTM-secured services like email or SNS, and finally a Banking Engine provides MTM-secured banking services such as a secured trusted banking client application. One Engine may request services from a second Engine, or delegate capabilities to the second. To realise such an MSM-based system, virtualization may be used, and the base Device Manufacturer's MTM may be implemented in hardware or in a hardware-supported trusted environment such as ARM's TrustZone or a System on Chip (SoC) solution with the other Engines'.MTMs in software. Alternatively, the Engines' MTMs could run without virtualization in the kernel mode of a hardened operating system, or even within the normal application execution environment provided by an operating system.

According to a recommendation within the TCG Mobile Reference Architecture, only program code should be checked for integrity; data integrity should be a function of the code that uses the data, because, as the Reference Architecture states, ‘it is virtually impossible to decide in advance what is “good” data (and hence prevent changes to it) or decide after the fact what is “bad” data (and hence trigger a reaction)’.

### CITATION LIST

### Patent Literature

PTL 1: U.S. Pat. No. 7,457,951

### Non Patent Literature

NPL 1: TPM Main Part 1 Design Principals, Specification Version 1.2, Revision 103
NPL 2: TCG Mobile Reference Architecture version 1.0 12 Jun. 2007
NPL 3: TCG Mobile Trusted Module Specification version 1.0 12 Jun. 2007

### SUMMARY OF INVENTION

### Technical Problem

U.S. Pat. No. 7,457,951 by Proudler et al (PTL 1), attempts to address the above issue of determining good and bad data by assuming data should not change when stored in memory belonging to a trusted environment, then differentiating between statistically insignificant flaws in the storage medium (so-called bit rot, the tendency for random bits to flip due to age, electrical spikes, or even cosmic rays) and significant alterations, but it is silent on how to respond to significant but expected changes to the data in any manner other than generating an alarm display.

However, for certain data, such as the Platform Configuration Registers (PCRs) stored within an MTM implemented in software, it is very much possible to differentiate between good and bad data, as only a few specific APIs may alter these PCRs, so good changes must only occur during the execution of these APIs.

What is needed, therefore, is a method for checking the integrity of blocks of data memory that will allow data to be changed when changes are expected to be made, but will detect data changes outside of the expected interval, so that the trust in the data can be maintained.

Furthermore, these specific APIs that change PCRs operate in a manner described by the parameters to the APIs, thus as well as only allowing changes during specific APIs, it is possible to only allow the expected change during specific APIs.

What is further needed is a method to predict the outcome of a PCR altering API, so that the integrity monitoring software can verify that only the expected alteration to the PCRs actually occurs.

Another important feature of the MTM described by the TCG is the ability to perform remote attestation, a feature that allows a third-party challenger to query the current state of a MTM as described by the integrity metrics held within PCRs. The returned state is combined with a nonce to prevent replay attacks and signed with a key held by the MTM and certified by a third party Certificate Authority (CA). However, although the PCR integrity metrics contain information about the state of the platform, there is no protection for the confidentiality of the result of the remote attestation.

What is further needed, then, is a means for an Engine stakeholder to supply an attestation encryption key to third parties that wish to perform remote attestation. There also needs to be a means whereby this attestation encryption key may be revoked independently of the other attestation encryption keys.

In the Multi-Stakeholder Model, as well as attesting to a stakeholder's engine's MTM, the MTM within the Device Manufacturer's engine may also need to be attested to in order to verify the environment within which the stakeholder's engine is running. However, since the two engines are supplied by two separate stakeholders, the challenger needs to be assured by the Device Manufacturer's engine that the reported stakeholder's engine's attestation results are trustworthy. Thus the Multi-Stakeholder Model defines a parent-child relationship, where the parent is the Device Manufacturer's engine, and all the other stakeholders' engines are children.

What is further needed, then, is a means for a challenger to challenge the parent Device Manufacturer's engine to demonstrate that the attestation result the challenger received from a stakeholder is, as far as the Device Manufacturer is able to verify, correct.

Furthermore, in the Multi-Stakeholder Model, when a challenger requests remote attestation from a parent Device Manufacturer's engine after a remote attestation from a child stakeholder's engine, the parent engine may not wish to return certain integrity values within PCRs relating to other stakeholder engines present on the device.

What is further needed, then, is a means for a Device Manufacturer's engine to limit the set of integrity values held the Device Manufacturer's engine's MTM returned to a challenger, based on the child stakeholder that the challenger had previously requested remote attestation from.

So, a method, system and computer program product for implementing data integrity maintenance and prediction within a child Engine by a parent Engine are proposed in this application. Furthermore, a method, system and computer program product for implementing remote attestation within the environment of the multi-stakeholder model are proposed in this application.

### Solution to Problem

Broadly speaking, the invention relates to improved techniques for protecting data stored on a computer-readable medium.

One aspect of the invention provides techniques for protecting data stored within a child trusted environment in order to, amongst other things, prevent malicious hackers from altering the data owned by the child trusted environment by having a parent trusted environment with a higher level of trust and/or security monitor the child's data looking for unexpected changes. Another aspect of the invention provides techniques for temporarily disabling such data protection to allow authorized or expected updates to the monitored data. Yet another aspect of the invention provides techniques for accepting such expected updates and re-enabling the data monitoring so that the updated data may be protected.

A further aspect of the invention provides techniques for predicting the outcome of an authorized or expected update in order to, amongst other things, detect a malicious hacker simultaneously performing an authorized or unexpected update to the monitored data.

A yet further aspect of the invention provides techniques for maintaining within the parent trusted environment an ongoing accumulation of the authorized or expected changes within the child trusted environment in order to, amongst other things, prevent a malicious hacker resetting the child trusted environment back to a previously state.

A yet further aspect of the invention provides techniques for a stakeholder to specify a public and private key pair that may be given to a third party in order to, amongst other things, control which third parties are allowed to perform remote attestation.

A yet further aspect of the invention provides techniques for a child trusted environment to inform a parent trusted environment that it has performed attestation with a third party and for the parent to verify that the child is correctly describing the operation in order to, amongst other things, provide a higher degree of trust of a parent in a child.

A yet further aspect of the invention provides techniques for a third party to inform a parent trusted environment of an attestation it has performed with a child trusted environment, and for the parent to verify that the third party's information agrees with the information received directly from the child in order to, amongst other things, provide a higher degree of trust of a parent in a child.

A yet further aspect of the invention provides techniques for a parent trusted environment to report to a third party only a subset of PCR data, dependent on the child that the third party has previously attested with in order to, amongst other things, provide a higher degree of privacy control to a device.

For example, an information processing device according to an aspect of the present invention includes: a Stakeholder engine including: i) a program storage unit configured to store executable code; and ii) a data storing unit configured to store data to be integrity-checked within a memory device; and a Device Manufacturer engine including: i) an integrity check value storage unit configured to store a reference integrity check value for the data to be integrity-checked; ii) an integrity-checking unit configured to check the integrity of the data against a reference value in the integrity check value storage unit; iii) an integrity check value calculating unit configured to calculate an integrity check value for data; and iv) a failure handling unit configured to invoke an error response when not disabled, wherein the Stakeholder engine further includes a data modification unit configured to modify the data stored in the data storing unit, and when a request is received from executing code stored within the program storage unit to modify the data to be integrity-checked, the data modification unit is configured to: a) disable the failure handling unit; b) perform requested modification of the data in the data storing unit; c) request the integrity check value calculating unit to calculate a new integrity check value for the data in the data storing unit; d) store the new integrity check value in the integrity check value storage unit; and e) re-enable the failure handling unit.

Furthermore, an information processing device according to an aspect of the present invention includes: a Stakeholder engine including: i) a program storage unit configured to store executable code; ii) a data storing unit configured to store data to be integrity-checked within a memory device; and a Device Manufacturer engine including: i) an integrity check value storage unit configured to store a reference integrity check value for the data to be integrity-checked; ii) an integrity-checking unit configured to check the integrity of the data against a reference value in the integrity check value storage unit; iii) an integrity check value calculating unit configured to calculate an integrity check value for data; iv) a failure handling unit configured to invoke an error response when not disabled; and v) a prediction unit configured to predict the outcome of an operation by a data modification unit, wherein the Stakeholder engine further includes the data modification unit configured to modify the data stored in the data storing unit, and when a request is received from executing code stored within the program storage unit to modify the data to be integrity-checked, the data modification unit is configured to: a) disable the failure handling unit; b) request the prediction unit to predict the outcome of the request; c) request the integrity check value calculating unit to calculate a predicted integrity check value for the predicted outcome; d) perform requested modification of the data in the data storing unit; e) request the integrity check value calculating unit to calculate a new integrity check value for the data to be integrity-checked; f) request the failure handling unit to record an error, in the case where the new integrity check value does not equal the predicted integrity check value; g) request the integrity-checking unit to update the stored integrity check value with new integrity check value; and h) re-enable the failure handling unit.

Furthermore, an information processing system according to an aspect of the present invention includes: a key issuing device including a key issuing unit configured to issue an attestation key; a challenger device including a challenger unit configured to issue a remote attestation challenge; and an attestation device including an attestation unit configured to respond to challenges, wherein: a) the key issuing unit is configured to issue an attestation key to the challenger, b) the challenger unit is configured to issue a challenge to the attestation unit using public portion of the attestation key, c) the attestation unit is configured to perform attestation based on the challenger's challenge, and d) the attestation unit is configured to return an attestation result encrypted with the public portion of the attestation key to the challenger.

Furthermore, an information processing system according to an aspect of the present invention includes: a key issuing device including a key issuing unit configured to issue an attestation key; a challenger device including a challenger unit configured to issue remote attestation challenges; and an attestation device including a first attestation unit configured to respond to challenges, wherein the attestation device further includes a second attestation unit configured to respond to challenges, the attestation device further includes a connector unit configured to allow the first attestation unit to communicate with the second attestation unit, a) the key issuing unit is configured to issue an attestation key to the challenger; b) the challenger unit is configured to issue a challenge to the first attestation unit using a public portion of the attestation key; c) the first attestation unit is configured to perform first attestation based on the challenger's challenge; d) the first attestation unit is configured to return a first attestation result encrypted with the public portion of the attestation key to the challenger; e) the connector unit is configured to communicate the first attestation result from the first attestation unit to the second attestation unit; f) the challenger unit is configured to issue a challenge to the second attestation unit; g) the second attestation unit is configured to perform second attestation based on the challenger's challenge and the first attestation result communicated through the connector unit; and h) the second attestation unit is configured to return a second attestation result to the challenger.

Furthermore, a method for executing a software routine according to another aspect of the present invention is a method for executing a software routine that may alter integrity-checked data, the method including: a) providing an integrity-checking unit that operates with higher privileges than the software routine; b) providing a reference integrity check value that describes a valid integrity value for the integrity-checked data; c) providing a failure handling unit that the integrity-checking unit calls in the case where the reference integrity check value does not equal a calculated integrity check value; d) disabling the failure handling unit; e) executing the software routine; t) calculating a new integrity check value for the integrity-checked data; g) updating the reference integrity check value with the new integrity check value; and h) re-enabling the failure handling unit.

Furthermore, a method for executing a software routine according to another aspect of the present invention is a method for executing a software routine that may alter integrity-checked data, the method including: a) providing an integrity-checking unit that operates with higher privileges than the software routine; b) providing a reference integrity check value that describes a valid integrity value for the integrity-checked data; c) providing a failure handling unit that the integrity-checking unit calls in the case where the reference integrity check value does not equal a calculated integrity check value; d) disabling the failure handling unit; f) calculating a predicted outcome for the software routine; h) calculating a predicted integrity check value for the predicted outcome; g) executing the software routine; h) calculating a new integrity check value for the integrity-checked data; i) calling the failure handling unit in the case where the new integrity check value does not equal the predicted integrity check Value; j) updating the reference integrity check value with the predicted integrity check value; and k) re-enabling the failure handling unit.

Furthermore, a method for performing remote attestation according to another aspect of the present invention is method for performing remote attestation between a challenger device and a client device, the method including: a) providing a key issuing device that issues an attestation key to the challenger device usable by the client device; b) providing an attestation unit on the client device that receives requests for attestation from the challenger, each of the requests for attestation including the public portion of an attestation key issued by the key issuing device; c) performing attestation by the attestation unit to get an attestation result; d) encrypting the attestation result with the public portion of an attestation key; and e) returning the encrypted attestation result to the challenger.

Furthermore, a method for performing remote attestation according to another aspect of the present invention is method for performing remote attestation between a challenger device and a client device, the method including: a) providing a first key issuing device that issues an attestation key to the challenger device usable by the client device; b) providing a first attestation unit on the client device that receives requests for attestation from the challenger, each of the requests for attestation including the public portion of an attestation key issued by the first key issuing device; b1) providing a second attestation unit on the client device that receives requests for attestation from the challenger; c) providing a connector unit that permits the first attestation unit to communicate with the second attestation unit; d) performing attestation by the first attestation unit to get a first attestation result; e) encrypting the first attestation result with the public portion of the first attestation key; f) returning the first encrypted attestation result to the challenger; g) communicating a message containing the first attestation result from the first attestation unit to second attestation unit using the connector unit; h) performing attestation by the second attestation unit to get a second attestation result; and i) returning, the second attestation result to the challenger.

Other aspects and advantages of the invention will become apparent from the following detailed description, taken in conjunction with the accompanying drawings, illustrating by way of example the principles of the invention.

### Advantageous Effects of Invention

According to the present invention, manipulation of data can be prevented and trust in data can be maintained.

### BRIEF DESCRIPTION OF DRAWINGS

A better understanding of the present invention can be obtained when the following detailed description of a preferred embodiment is considered in conjunction with the following drawings, in which:

FIG. 1 illustrates a mobile device according to the prior art.

FIG. 2 illustrates a mobile device according to the present invention.

FIG. 3 illustrates an Engine Certificate according to the prior art.

FIG. 4 illustrates a timeline of interactions between engines.

FIG. 5 illustrates the behaviour on startup.

FIG. 6 illustrates the Child Engine Table.

FIG. 7 illustrates the behaviour on a timer event.

FIG. 8 illustrates the behaviour of a hook function at API entry.

FIG. 9 illustrates the behaviour of a hook function at API exit.

FIG. 10 illustrates creation of a replacement Engine Certificate.

FIG. 11 illustrates the behaviour on a timer event according to another embodiment.

FIG. 12 illustrates the behaviour of a hook function at API exit according to another embodiment.

FIG. 13 illustrates the Child Engine Table according to another embodiment.

FIG. 14 illustrates the behaviour of a hook function at API entry according to another embodiment.

FIG. 15 illustrates predicting the outcome of an operation.

FIG. 16A illustrates the behaviour on a timer event according to another embodiment.

FIG. 16B illustrates the behaviour on a timer event according to another embodiment.

FIG. 17 illustrates the behaviour of a hook function at API exit according to another embodiment.

FIG. 18 illustrates replacing an Engine Cert.

FIG. 19A illustrates remote attestation according to the prior art.

FIG. 19B illustrates remote attestation according to the prior art.

FIG. 20A illustrates remote attestation according to the present invention.

FIG. 20B illustrates remote attestation according to the present invention.

FIG. 21 illustrates TPM_VERIFICATION_KEY structure according to the prior art.

FIG. 22A illustrates loading and verifying a TPM_VERIFICATION_KEY.

FIG. 22B illustrates loading and verifying a TPM_VERIFICATION_KEY.

FIG. 23A illustrates remote multi-stakeholder attestation according to the present invention.

FIG. 23B illustrates remote multi-stakeholder attestation according to the present invention.

FIG. 24A illustrates remote multi-stakeholder attestation according to the present invention.

FIG. 24B illustrates remote multi-stakeholder attestation according to the present invention.

FIG. 25 illustrates verifying a reported quote value.

FIG. 26 illustrates the Pending Attestation Table.

FIG. 27 illustrates verifying a child attestation result issued by a challenger.

FIG. 28 illustrates removing, a used child attestation result.

FIG. 29 illustrates the Child Engine PCR Access Table.

FIG. 30 illustrates remote multi-stakeholder attestation manufacturing according to another embodiment.

FIG. 31 illustrates remote multi-stakeholder attestation according to another embodiment.

### DESCRIPTION OF EMBODIMENTS

Details of the preferred embodiments of this invention are described below.

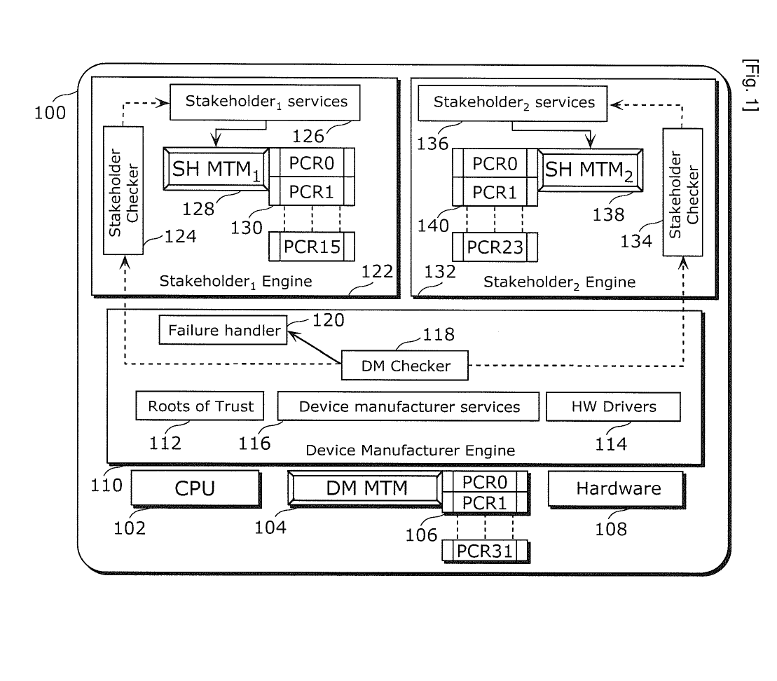

FIG. 1 illustrates the Multi-Stakeholder Model prior art according to an embodiment of the TCG Mobile Reference Architecture when the system comprises of a Device Manufacturer's (DM) engine and two Stakeholders' engines, focusing on the integrity checking functionality. In one embodiment of the Multi-Stakeholder Model the first stakeholder is the mobile service carrier and the second stakeholder is the mobile service operator. First, there is the mobile device 100 that consists of the components to be described below. Starting from the bottom there is the central processing unit, CPU, 102, the Device Manufacturer's Mobile Trusted Module 104 which contains the Platform Configuration Registers 106 numbered PCR0 to PCR31, and the device hardware 108. Next, there is the Device Manufacturer Engine 110 that contains the Roots of Trust 112, Hardware Drivers 114 for the Hardware 108, and the various Device Manufacturer services 116 provided by the manufacturer for use by other components within the system. One ordinarily-skilled in the art will see that the DM MTM 104 and PCRs 106 may not necessarily be on a distinct component but may be implemented in software or firmware within the Device Manufacturer Engine 110. Next, there is a DM Checker 118 that as described by the TCG Mobile Reference Architecture is responsible for monitoring the integrity of not just services within its own engine, but also monitors the integrity of the Stakeholder Checkers 124 and 134 within the Stakeholder₁ Engine 122 and the Stakeholder₂ Engine 132. These Stakeholder Checkers 124 and 134 check the integrity of components within the Stakeholder₁ Engine 122 and the Stakeholder₂ Engine 132 respectively. The operation of a Stakeholder Checker is the same as that of an SRMVA as described within the TCG Mobile Reference Architecture. If the DM Checker 118 detects an integrity error, there is a Failure handler 120 that handles failures by taking suitable action such as disabling all trusted operations within all the engines or rebooting the device, and the operation of a Failure handler is the same as that of a TCG_Reactivbe capability as described within the TCG Mobile Reference Architecture.

Next, Stakeholder₁ Engine 122 contains Stakeholder Checker 124 as described above, which checks the integrity of Stakeholder₁ services 126. These services interface with the Stakeholder's SH MTM₁ 128 to provide trusted services to clients as required. It should be noted that Stakeholder₁ services 126 and the SH MTM₁ 128 are examples of a program storage unit configured to store executable code. The SH MTM₁ 128 has a set of PCRs 130, numbered PCR0 to PCR15. It should be noted that the SH MTM₁ 128 is an example of a data storing unit configured to store data to be integrity-checked within a memory device. The TCG specifications state only a minimum number of PCRs within a single trusted module, so embodiments of this invention may have more or less PCRs per trusted module. Stakeholder₂ Engine 132 has a similar construction of Stakeholder Checker 134, Stakeholder₂ services 136, SH MTM₂ 138 and PCR0 to PCR23 140. Although the three engines 110, 112 and 132 are illustrated within FIG. 1 as distinct entities, their separation may be purely, a logical division, or they may be each within separate virtual machines, or they may use policy-based enforcement of process separation, or any combination of the above or other techniques well-known in the art. Regardless of the implementation of the three engines, there is also a logical hierarchy with the Device Manufacturer Engine 110 being a more trustworthy parent and the Stakeholder engines 122 and 132 being less trustworthy children. It should be noted that the Device Manufacturer Engine 110 operates with higher privileges than the Stakeholder engines 122 and 132. Stated differently, the Device Manufacturer Engine 110 includes an integrity-checking unit that operates with higher privilege-s than the software routine executed by the Stakeholder engines 122 and 132. Within the figure, the use of dotted arrowed lines indicates integrity checks that are performed by a more trustworthy component on a less trustworthy component. These integrity checks may be performed asynchronously. As defined by the TCG Mobile Reference Architecture, integrity checks are performed by calculating a cryptographic hash of the data to protect, then comparing that value with a reference value.

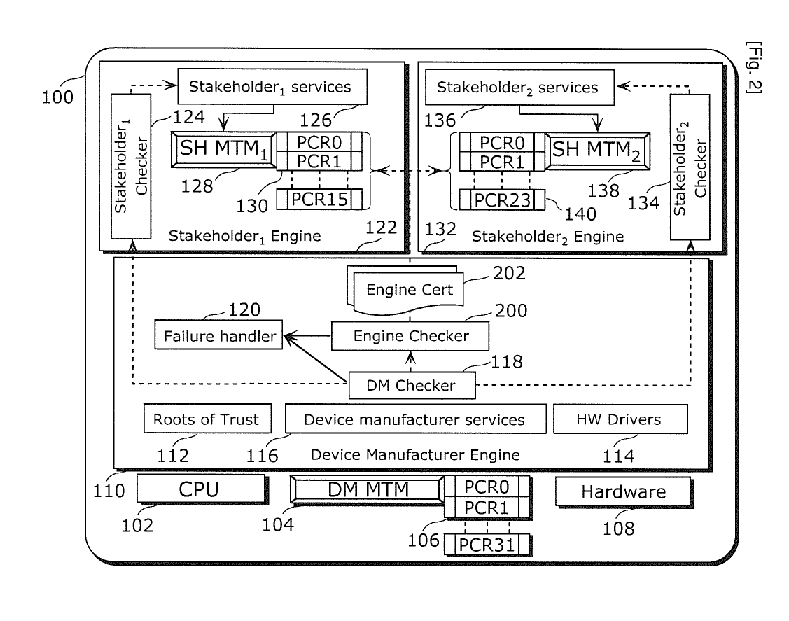

FIG. 2 illustrates the Multi-Stakeholder Model according to the present invention and based upon the prior art described in FIG. 1. The existing integrity checking functionality as supported by the DM Checker 118 and the Stakeholder Checkers 124 and 134 is preserved, but in addition an Engine Checker 200 has been added to implement the additional data integrity maintenance within the child Stakeholder engines 122 and 132 by the parent Device Manufacturer engine 110. According to the present invention the Stakeholder MTM₁ 128 and MTM₂ 138 are implemented in software and the sets of PCRs 130 and 140 are implemented in non hardware-protected memory. The Engine Checker 200 asynchronously monitors the integrity of the stakeholders' engines' MTMs' PCRs 130 and 140, using the Engine Certs 202 to store integrity reference values that are used to detect unexpected changes to the PCR sets 130 and 140, and if an unexpected change is detected, the Failure handler 120 is used to handle the failure case. It should be noted that the Engine Certs 202 is an example of an integrity check value storage unit configured to store a reference integrity check value for the data to be integrity-checked. Furthermore, the Engine Checker 200 is an example of an integrity-checking unit configured to check the integrity of the data against a reference value in the integrity check value storage unit. In addition, the Engine Checker 200 is an example of an integrity check value calculating unit configured to calculate an integrity check value for data. For example, the Engine Checker 200, which is an example of an integrity check value calculating unit, is configured to calculate a cryptographic hash value. Furthermore, the Failure handler 120 is an example of a failure handling unit configured to invoke an error response when not disabled.

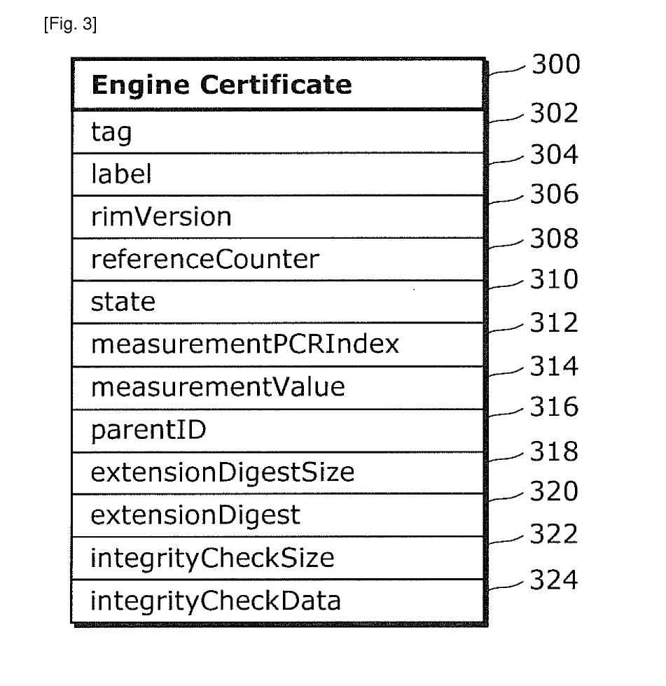

FIG. 3 illustrates the structure of an Engine Certificate according to the prior art. This Engine Certificate format 300 is identical in format to the prior art of the Mobile Phone Working Group's RIM Certificate structure, but with some fields interpreted differently. First, the tag 302, label 304 and rimVersion fields 306 retain their predefined meaning. In a preferred implementation the label field 304 used is ‘ShExx_yy’ where the characters ‘ShE’ indicate this certificate is a stakeholder's engine data certificate, ‘xx’ is a numeric identifier representing a particular stakeholder's engine, and ‘yy’ is a numeric identifier representing which particular data item within the engine is being protected. The rimVersion field 306 contains a counter that starts at zero after a reboot, and increments by one every time a new Engine Certificate with a given label is updated. The referenceCounter 308 is defined as holding a monotonic counter, but within in a preferred implementation this monotonic counter is not necessary; as monotonic counters are a shared and limited resource, a preferred implementation employs an alternative method for establishing the currency of a certificate as the currency does not need to be preserved over restarts of the system. The state field 310 is defined as describing the expected PCR state; this is the state of the Device Manufacturer Engine 110; in a preferred implementation it describes the state that includes PCR31 or other register assigned for use for protection against rollback attacks. In a preferred implementation measurementPCRIndex field 312 holds the value 31, representing PCR31 as the target of the extend operation using the value held in measurementValue field 314. The choice of which register to use for protection against rollback attacks is made by the Device Manufacturer. As illustrated in detail in the figures below, after an update is made to data monitored by an Engine Cert 202 the indicated measurementValue 314 is extended into the register described by measurementPCRIndex 312 by performing a cumulative hash operation on the appropriate PCR 106 in the Device Manufacturer MTM 104. Thus, an attacker cannot rollback the state of a stakeholder's engine then rollback the Engine Cert 202 used to protect it as the state field 310 will describe a value of the measurementPCRIndex 312 register that is incorrect. This measurementValue 314 holds a representative value of the data within the stakeholder's engine that it is monitoring, which in a preferred implementation is a known good cryptographic hash of data such as the PCRs 130 or 140, and this value is used to verify whether or not the integrity of the monitored data has been compromised. If there are multiple Stakeholder engines present on a device, one ordinarily-skilled in the art will realise that each engine may be assigned a separate PCR to record its state. parentID field 316 is set to a sentinel value TPM_VERIFICATION_KEY_ID_INTERNAL to indicate that the integrityCheckData field 324 is signed with an internal verification key as described in the prior art. extensionDigestSize field 318 is 0 thus the extensionDigest field 320 is zero bytes long in a preferred implementation. Finally, integrityCheckSize field 322 and integrityCheckData field 324 contain an integrity check value for the rest of the fields 302 to 320 as described by the prior art.

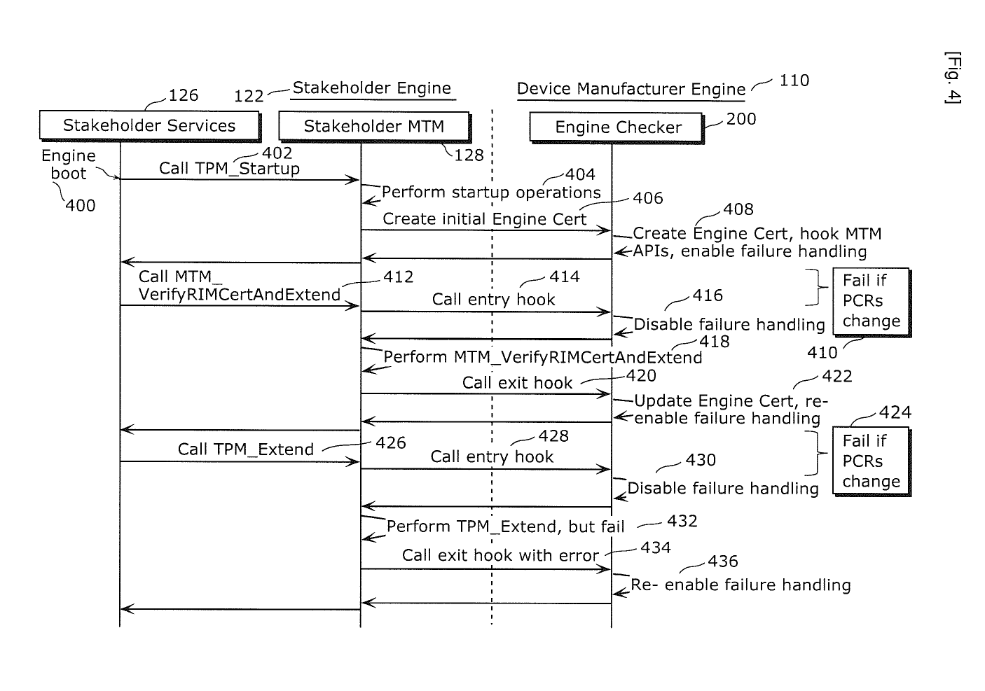

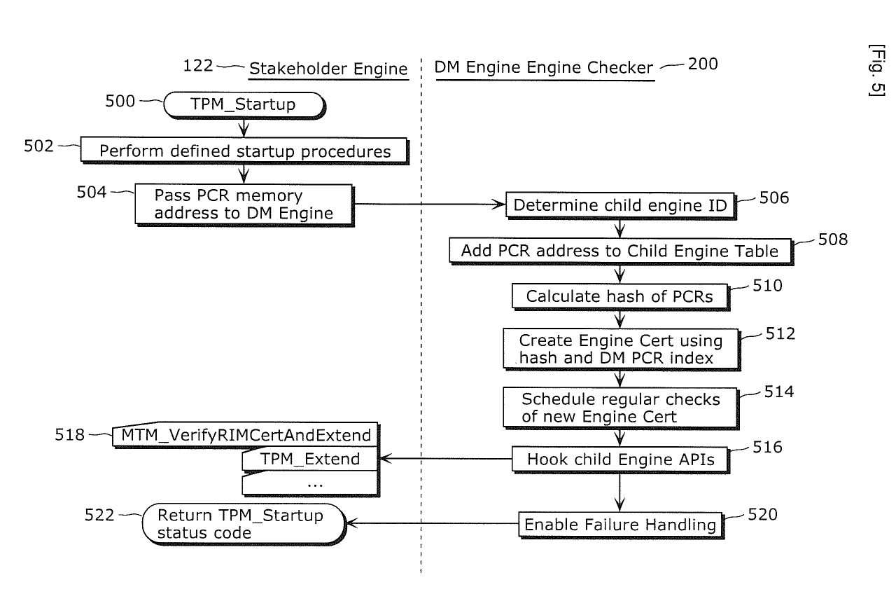

FIG. 4 illustrates an example flow of events on a device according to the present invention. A detailed description of each of the events is presented later. The left side of the diagram indicates the sequence of events within the Stakeholder Engine 122 regarding the Stakeholder Services 126 and Stakeholder MTM 128, and the right side the events within the Device Manufacturer Engine 110 regarding the Engine Checker 200. According to the prior art, on Engine boot 400 there is a call to the TPM_Startup API 402. This performs the startup operations 404 as defined in the prior art, but before returning control it calls an API in the Engine Checker 200 that requests creation of an initial Engine Cert 406. The Engine Checker module within the Device Manufacturer's engine creates an Engine Cert, hooks into the stakeholder's engine's MTM API that may potentially alter PCR values, and enables the failure handling routine on detection of an integrity check failure of the memory monitored by the Engine Cert 408. The details of this process are illustrated in FIG. 5. Control is then passed back to the Stakeholder Services 126. While other operations happen, there is an asynchronous event generator that calls an integrity-checking routine that verifies that the memory protected by the Engine Cert has not changed, but if it detects change in the protected memory it will fail 410, calling the Failure handler 120.

Next, the Stakeholder Services 126 wishes to alter a PCR within the set of PCRs 130 managed by this stakeholder by calling the MTM_VerifyRIMCertAndExtend API 412 with appropriate parameters. Before the Stakeholder MTM can process the request, the previously-installed hook function is called 414 and the Engine Checker 200 disables failure handling 416 so that the asynchronous checking will not cause a failure if the PCRs change 410. Control is passed back to the Stakeholder MTM 128 which performs the required verification of the parameters and the update of PCRs 418, and before returning control back to the caller, the exit hook 420 is called and the Engine Checker updates the hash value held within the Engine Cert to reflect the updated PCRs and re-enables the failure handling 422 on the asynchronous checking 424, then control can be passed back to the calling Stakeholder Services 126.

Next, to illustrate how a failure by the stakeholder's engine to alter a PCR within the set of PCRs 130 managed by this stakeholder through an API is dealt with, the Stakeholder Services 126 calls the TPM_Extend API 426. Before the Stakeholder MTM can process the request, the previously-installed hook function is called 428 and the Engine Checker 200 disables failure handling 430 so that the asynchronous checking will not cause a failure if the PCRs 130 within the stakeholder's engine change 424. Control is passed back to the Stakeholder MTM 128 which attempts to perform the TPM_Extend operation, but fails 432. A failure notification is passed to the exit hook function 434, so the Engine Checker 200 just re-enables the failure handling 436 because due to the error the integrity-checked PCRs did not change, so the Engine Cert previously generated at 422 still represents the expected values of the PCRs. Finally, control is passed back to the Stakeholder Services 126.

It should be noted that the Stakeholder. MTM 128 is an example of a data modification unit configured to modify the data stored in the data storing unit. As described above, when a request is received from executing code stored within the program storage unit to modify the data to be integrity-checked, the data modification unit is configured to: a) disable the failure handling unit; b) perform requested modification of the data in the data storing unit; c) request the integrity check value calculating unit to calculate a new integrity check value for the data in the data storing unit; d) store the new integrity check value in the integrity check value storage unit; and e) re-enable the failure handling unit.

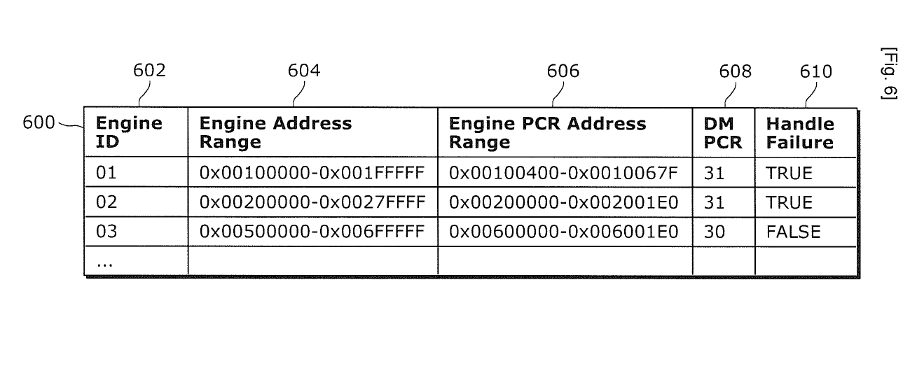

FIG. 5 illustrates the flow chart for initialising the Engine Checker during the TPM_Startup API. On the left hand side are processes that occur within in the child Stakeholder Engine 122, and on the right hand side are processes that occur within the parent Device Manufacturer Engine's Engine Checker 200 that form part of the present invention. After the entry into the TPM_Startup API 500, the procedures for an MTM startup are performed 502 as defined by the prior art. Just before the routine returns, however, the routine passes the memory address of the PCRs 130 managed by the stakeholder to the DM Engine 504. Control is passed to the Engine Checker 200 within the DM Engine where first of all the identity of the calling child stakeholder engine is determined 506. In a preferred implementation the return address of the calling function is used to look up the Child Engine Table 600 illustrated in FIG. 6. Depending on the method chosen to separate the Stakeholder Engine 122 and the Device Manufacturer Engine 110, the Device Manufacturer may need to translate the address of the calling child and the address of the PCRs, such as in a virtualized environment mapping the Stakeholder virtual address locations to the Device Manufacturer physical addresses, using techniques well-known in the art. With the child stakeholder engine identity established, the PCR memory address location information is added 508 to the Child Engine Table 600. Next, a hash of the PCRs within the child stakeholder engine is calculated 510 using an algorithm such as MD4, MD5, SHA1, or SHA256. Although algorithms such as MD4 and MD5 are vulnerable to collision attacks, since the PCR memory size is a fixed size and the lifetime of the hash measurement is relatively short the scope for such an attack is limited. It is also not necessary to salt the hash in the preferred implementation as the reference hash is stored within an Engine Cert that is protected by an HMAC, thus the reference hash is not vulnerable to attack. One ordinarily-skilled in the art will therefore see that choosing a high-performance cryptographic hash function does not trade off speed for security.

The next step is to create the Engine Cert for the current hash of the PCRs 512. First the tag 302 is set to TPM_TAG_RIM_CERTIFICATE; the label 304 is set to ‘ShExx_yy’ with ‘xx’ set to the value indicated in the Child Engine Table 600 and ‘yy’ set to ‘00’ to indicate a PCR-checking certificate; a rimVersion 306 of 0; a referenceCounter 308 with the counterSelection field set to MTM_COUNTER_SELECT_NONE; a state 310 set to represent the PCR index and the current value of the PCR as indicated in the Child Engine Table 600 for this engine ID; measurementPcrIndex 312 set to the PCR index indicated in the Child Engine Table 600; measurementValue 314 set to the hash calculated in 510, padded with zeros if the hash value is shorter than the field size; the extensionDigestSize 318 set to zero thus making the extensionDigest field 320 empty. The rest of the fields may be left blank, as this structure is passed into the MTM_InstallRIM API which fills out the missing fields and signs the structure. Next, the Engine Checker schedules regular checks of the Engine Cert 514. The scheduling for the checking is described in the Mobile Reference Architecture and the TCG Mobile Abstraction Layer documents with reference to Watchdog Timers and RIM_Run certificates, so in a preferred implementation the Engine Checker uses such scheduling to perform checking as a low intensity background process to avoid spikes in processor demand and the interruption of other activities. In addition, the Engine Cert is further checked when particular events occur, such as before any MTM functions that read current PCR values. Next, the Engine Checker hooks 516 the child stakeholder engine APIs 518 that may potentially alter PCRs values. These APIs needing hooked include TPM_Extend, TPM_PCR_Reset, and MTM_VerifyRIMCertAndInstall, and the hook installed adds calls to the Engine Checker on both entry to and exit from each of the APIs. Specific implementations of the TCG specifications may have other PCR-altering functions that also need to be hooked. Finally, the Engine Checker enables failure handling 520 for the created Engine Cert by setting the Handle Failure flag 610 to TRUE. The Engine Checker's initialisation is now complete, so control is returned to the stakeholder's engine, which finishes off the TPM_Startup processing by returning the status code 522 generated during the startup procedures 502.

FIG. 6 illustrates the Child Engine Table used by the Device Manufacturer Engine. The Child Engine Table 600 consists of four columns. First, the Engine ID field 602 contains the two character code that is used to create the tag 302 for the child's Engine Cert, so for the first row in the table the tag 302 will be ‘ShE01_00’. The Engine Address Range 604 indicates the address range within which the child engine has been created. In a preferred implementation, the address range is a single contiguous block of memory, but one ordinarily-skilled in the art will see that multiple non-contiguous blocks may be used instead, as may more complex addressing schemes. Similarly, the Engine PCR Address Range 606 indicates the address range within which the child stakeholder engine's PCRs are located. In a preferred implementation, the address range is a single contiguous block of memory, but one ordinarily-skilled in the art will see that multiple non-contiguous blocks may be used instead, as may more complex addressing schemes, such as in the case of virtualization physical addresses may be stored rather than the virtual addresses used by the child stakeholder engine itself. DM PCR 608 contains the Device Manufacturer engine PCR that is to be used for the measurementPcrIndex 312 within the child's Engine Cert. More than one child engine can share the same PCR within the Device Manufacturer engine, as illustrated in the DM PCR 608 column where both Engine ID 01 and 02 use PCR 31, but Engine ID 03 uses PCR 30. Furthermore, the decision on which PCR within the Device Manufacturer engine to use is taken by the Device Manufacturer; the child engine does not need to know the PCR used. The Handle Failure field 610 indicates whether or not integrity failures should invoke a Mandatory Error Response. This table is maintained by the Device Manufacturer, and one ordinarily-skilled in the art will see that one of the ways whereby the maintenance of the table may be performed is a similar manner to that described within the TCG Mobile Reference Architecture for the DM Mandatory Engine Lists, and that the table's integrity may be maintained by storing a reference hash of the table for verification whenever it is used.

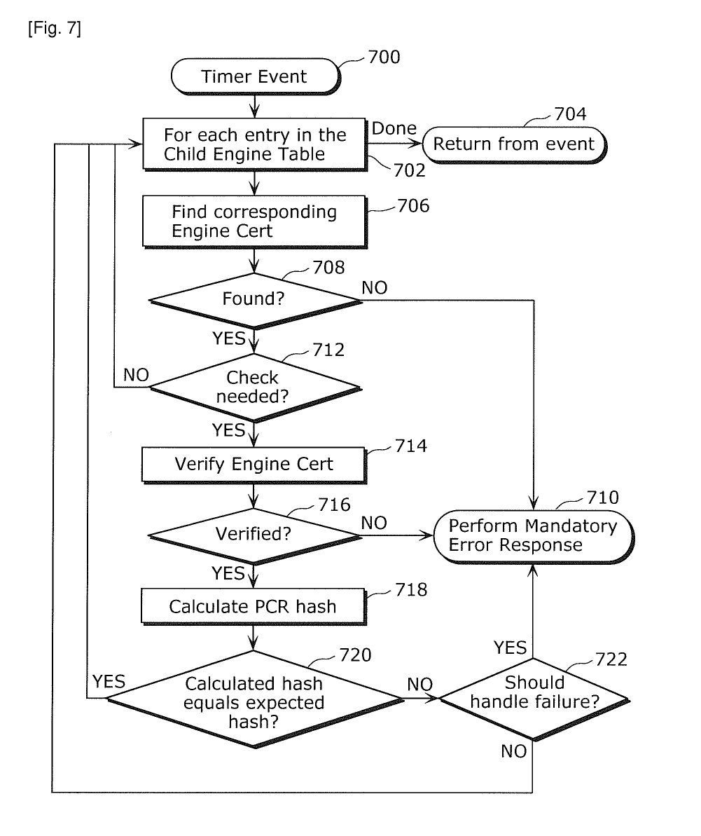

FIG. 7 illustrates the flow chart for processing a timer event within the Engine Checker. The handling is all done within the DM Engine Engine Checker module 200, and starts at 700 when invoked from existing timer event processing for the PRMVA as described in the prior art. The routine processes each row 702 within the Child Engine Table 600 until it completes and returns successfully from the event 704. Error handling is described below. As described previously, the name of the Engine Cert for each row is generated from the Engine ID field 602, and this name is used to find the corresponding Engine Cert 706 from within the RIM Certificate Database. The RIM Certificate Database is a store of all the RIM Certificates, of which Engine Certs are a subset, within the device. The TCG Mobile Abstraction layer describes an interface for accessing the certificates held within this store. If the certificate is not found 708, then control is passed to the Mandatory Error Response 710 and appropriate action is taken as described in the prior art. Otherwise, the event handler determines whether or not this Engine Cert needs to be checked 712. As described in step 514 in FIG. 5, the Engine Checker schedules regular integrity checks of the memory protected by the Engine Cert 514, so not all certificates are necessarily checked every time an event occurs. If there is no check needed, then the next entry in the Child Engine Table is checked. If there is a check needed, next the Engine Cert is verified 714. This verification consists of checking the state field 310 describes the current state of the Device Manufacturer's MTM's PCRs, and that the integrityCheckData field 324 is a valid signature. If there is a verification failure 716, then control is passed to the Mandatory Error Response 710 and appropriate action is taken as described in the prior art. Next, the Engine PCR Address Range 606 information is used to generate a cryptographic hash of the child engine's PCRs 718, and the result is compared with the measurementValue field 314 within the Engine Cert 720. If the values do match, then the data has been determined to have not been tampered with, so the next entry in the Child Engine Table is processed 702. However, if the values do not match, then the Handle Failure flag 610 is checked. If the flag is TRUE, then control is passed to the Mandatory Error Response 710 and appropriate action is taken as described in the prior art. If it is FALSE, then the hash error is to be ignored, so control is passed back to the top of the event handler so that the next entry in the Child Engine Table may be processed 702.

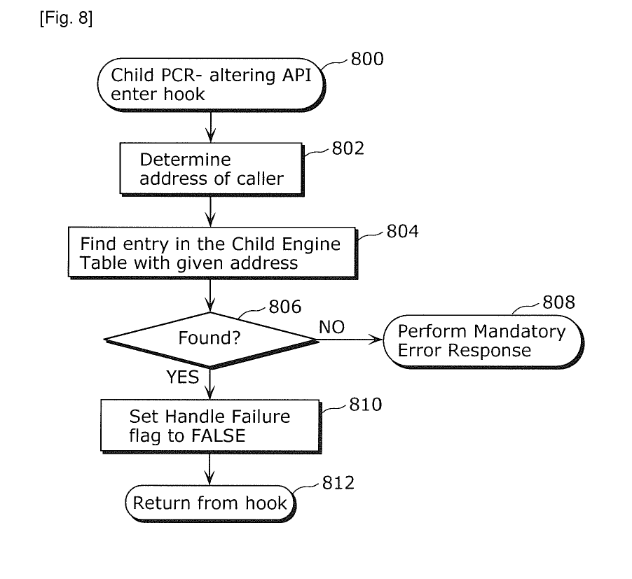

FIG. 8 illustrates the flowchart for processing a call from a child engine into the Device Manufacturer's engine from the entry point of a hooked routine as installed at 516. After entering the hook 800, the address of the called is determined 802. According to a preferred implementation the calling address is passed in as an argument, but one ordinarily-skilled in the art will see that other methods such as examining the call stack to determine the entry point are possible. This address (in a virtualized environment, virtual addresses are first translated into physical addresses) is used to look up the Child Engine Table's Engine Address Range 604 field to find the row with an address range within which the caller's address falls 804. If no match is found 806, then control is passed to the Mandatory Error Response 808 and appropriate action is taken as described in the prior art. Otherwise, the Handle Failure flag 610 for the row is set to FALSE 810, and control is passed back to the caller 812 to continue the processing of the PCR-altering API.

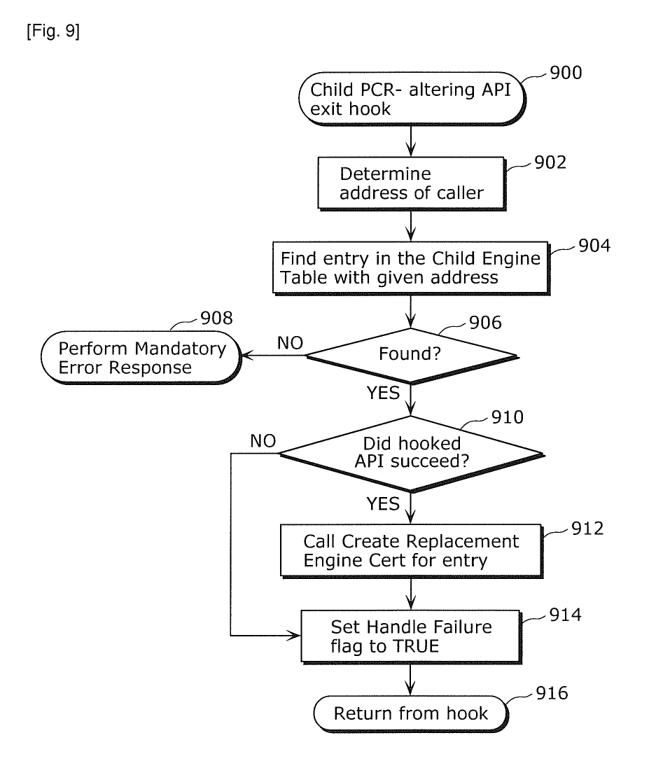

FIG. 9 illustrates the flow chart for processing a call from a child engine into the Device Manufacturer's engine from the exit point of a hooked routine as installed at 516. After entering the hook 900, the address of the caller is determined 902. According to a preferred implementation the calling address is passed in as an argument, but one ordinarily-skilled in the art will see that other methods such as examining the call stack to determine the entry point are possible. This address is used to look up the Child Engine Table's Engine Address Range 604 field to find the row with an address range within which the caller's address falls 904. If no match is found 906, then control is passed to the Mandatory Error Response 908 and appropriate action is taken as described in the prior art. Now, the return code from the hooked API is checked to see if the API succeeded in altering any PCRs 910. The TCG Mobile Trusted Module Specification and the TCG Main Part 3 documents describe for each command all the possible return codes, with a return code of TPM_SUCCESS indicating a successful change to a PCR, and all other codes indicating no change to the PCRs. Thus, if the return code is TPM_SUCCESS, then the child engine's PCRs have changed, so code to create a replacement Engine Cert 912 for this entry in the Child Engine Table is called. After this call, or if the hooked API failed, the current entry also needs to get the Handle Failure flag set to TRUE 914 to re-initiate error failure handling during timer events as illustrated in FIG. 7.

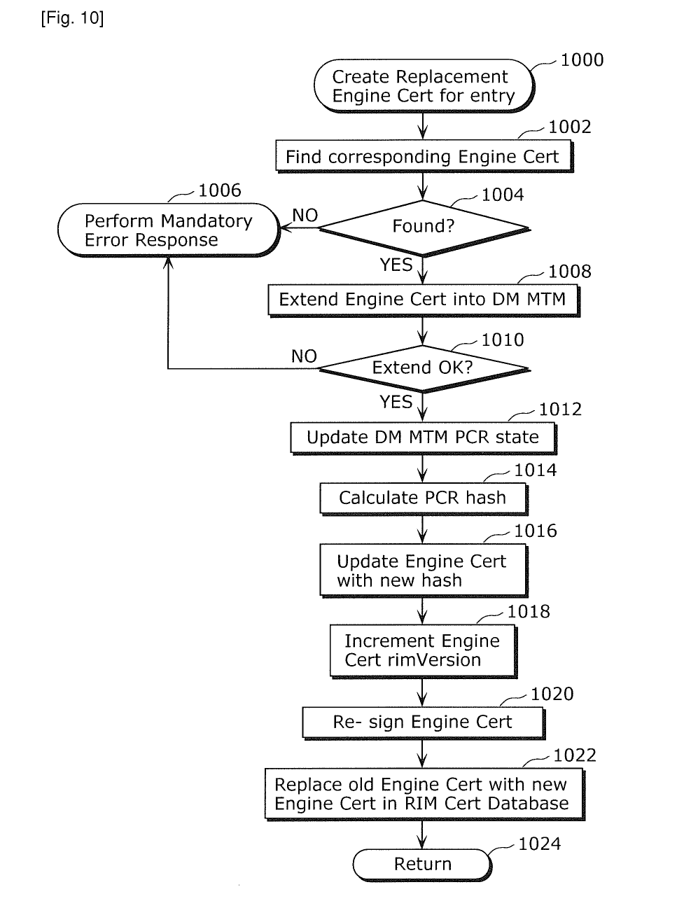

FIG. 10 illustrates the flow chart for creating a replacement Engine Cert 1000 for a given entry row in the Child Engine Table 600, providing the details for the Update Engine Cert, re-enable failure handling step 422 in FIG. 4. As described previously, the name of the Engine Cert for each row is generated from the Engine ID field 602, and this name is used to find the corresponding Engine Cert 1002 from within the RIM Certificate Database. If the certificate is not found 1004, then control is passed to the Mandatory Error Response 1006 and appropriate action is taken as described in the prior art. Otherwise, the Engine Cert is extended into the Device Manufacturer's MTM 1008 using the MTM_VeritfyRIMCertAndExtend API. If the operation fails, then control is passed to the Mandatory Error Response 1006 and appropriate action is taken as described in the prior art. Otherwise, the state field 310 within the Engine Cert is updated 1012 to reflect the change to the PCR indicated by the measurementPcrIndex 312. Next, the Engine PCR Address Range 606 information is used to generate a cryptographic hash of the child engine's PCRs 1014, and the result is assigned to the measurementValue field 314 within the Engine Cert 1016. Next, the rimVersion field 306 in the Engine Cert is incremented 1018 to indicate the new version of the Engine Cert, and the Device Manufacturer's MTM is requested to sign the new RIM Certificate 1020 using the MTM_InstallRIM API as described in the prior art. The old Engine Cert on RAM is replaced with the newly generated one within the RIM Cert Database 1022 using the API described by the TCG Mobile Abstraction Layer, then failure handling is re-enabled 1024 by setting the Handle Failure flag 610 for the current row and finally control is passed back to the caller 1024.

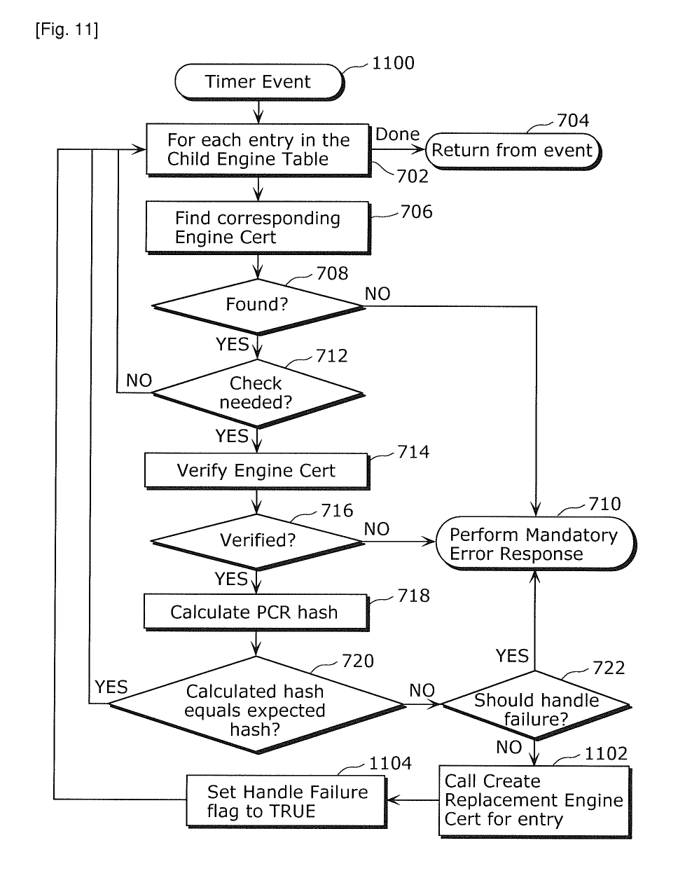

In another preferred embodiment of the system, rather than wait until the API finishes before updating the Engine Cert, FIG. 11 illustrates the flow chart for creating the replacement Engine Cert during a timer event 1100. This flow chart is based on FIG. 7, with the altered functionality present after a PCR hash value mismatch is detected but the Handle Failure flag 610 is set to FALSE 722. Rather than ignoring the error, code as illustrated in FIG. 10 to create a replacement Engine Cert 1102 for this entry in the Child Engine Table is called. Next, the Handle Failure flag is set to TRUE 1104, thus preventing further changes to the PCRs, rather than delaying the update until the exit hook function is called.

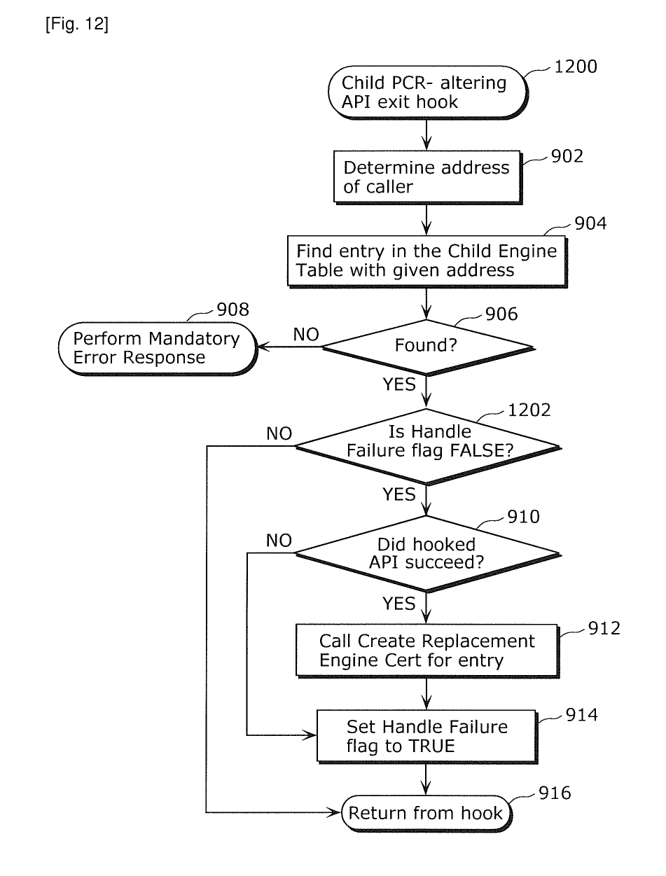

FIG. 12 illustrates the flow chart for the exit hook functionality for this alternative embodiment, based on the flow chart illustrated in FIG. 9. The one additional step in the hook function for a child function that alters PCRs 1200 is to check the state of the Handle Failure flag 1202. If the flag is set to FALSE, it means that timer event has not run yet, so the generation of a replacement Engine Cert 912 may need to take place. If the flag is set to TRUE, then the timer event has run and a new Engine Cert has been generated, thus no extra processing is needed.

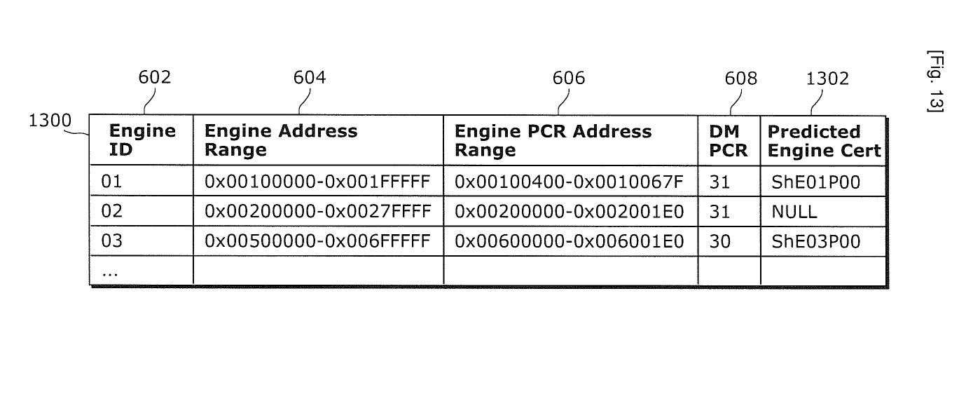

In another preferred embodiment of the system, the Engine Checker 200 predicts the outcome of a hooked API by simulating the operation of the API in order to ensure that only the changes to the PCRs described by the API parameters are performed. Specifically, the Engine Checker 200 is an example of a prediction unit configured to predict the outcome of an operation by a data modification unit. The hooked APIs, as noted before, include TPM_Extend, TPM_PCR_Reset, and MTM_VerifyRIMCertAndlnstall. FIG. 13 illustrated the Child Engine Table used by the Device Manufacturer Engine for this embodiment based on the table illustrated in FIG. 6. The Child Engine Table 1300 consists of four columns. First, the Engine ID field 602 contains the two character code that is used to create the tag 302 for the child's Engine Cert, so for the first row in the table the tag 302 will be ‘ShE01_00’. The Engine Address Range 604 indicates the address range within which the child engine has been created. In a preferred implementation, the address range is a single contiguous block of memory, but one ordinarily-skilled in the art will see that multiple non-contiguous blocks may be used instead, as may more complex addressing schemes. Similarly, the Engine PCR Address Range 606 indicates the address range within which the child engine's PCRs are located. In a preferred implementation, the address range is a single contiguous block of memory, but one ordinarily-skilled in the art will see that multiple non-contiguous blocks may be used instead, as may more complex addressing schemes. DM PCR 608 contains the Device Manufacturer engine PCR that is to be used for the measurementPcrIndex 312 within the child's Engine Cert. The Predicted Engine Cert field 1302 holds the name of the Predicted Engine Cert, or NULL is there is no pending prediction. A Predicted Engine Cert has a format identical to that illustrated in FIG. 3 for Engine Certs. This table is maintained by the Device Manufacturer, and one ordinarily-skilled in the art will see that one of the ways whereby the maintenance of the table may be performed in a similar manner to that described within the TCG Mobile Reference Architecture for the DM Mandatory Engine Lists, and that the table's integrity may be maintained by storing a reference hash of the table for verification whenever it is used.

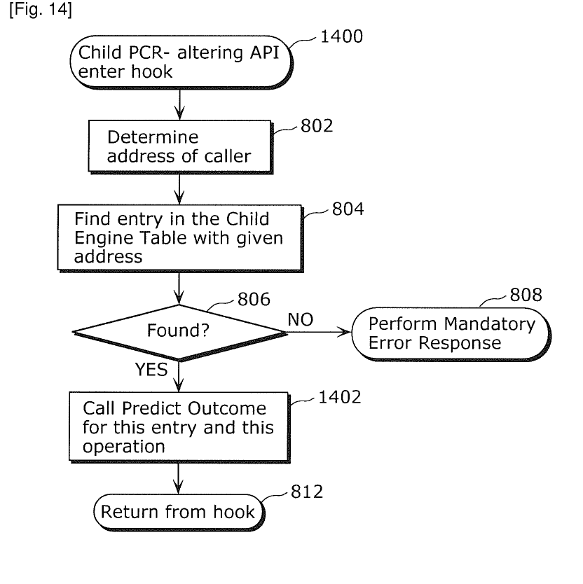

FIG. 14 illustrates the flow chart for processing a call from a child engine into the Device Manufacturer's engine from the entry point of a hooked routine as installed at 5.16, based on the processing illustrated in FIG. 8. After entering the hook 1400, the address of the called is determined 802. According to a preferred implementation the calling address is passed in as an argument, but one ordinarily-skilled in the art will see that other methods such as examining the call stack to determine the entry point are possible. This address is used to look up the Child Engine Table's Engine Address Range 604 field to find the row with an address range within which the caller's address falls 804. If no match is found 806, then control is passed to the Mandatory Error Response 808 and appropriate action is taken as described in the prior art. Otherwise, the Predict Outcome function is called 1402, and if it succeeds control is passed back to the caller 812 to continue the processing of the PCR-altering API.

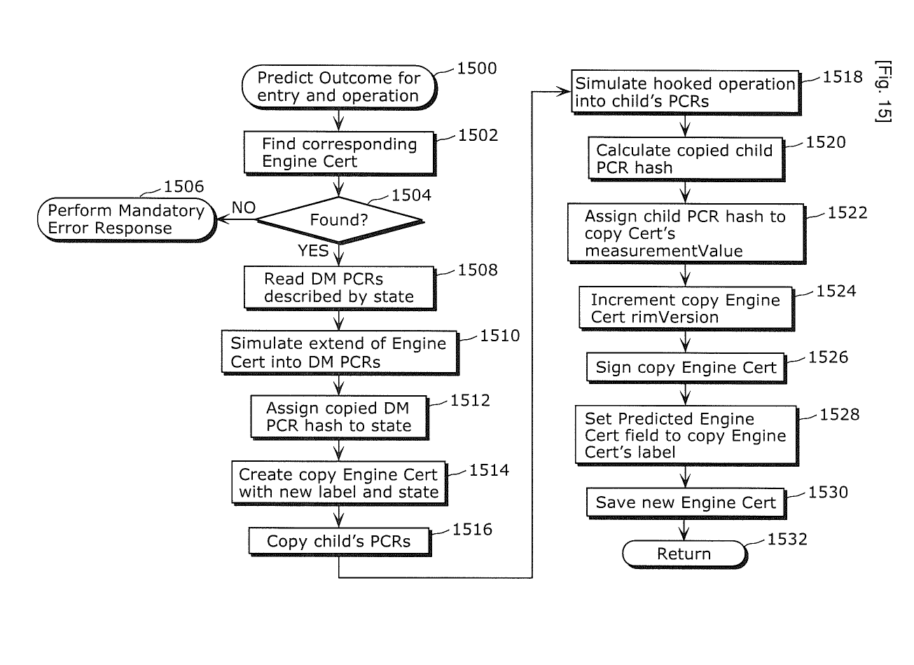

FIG. 15 illustrated the flow chart for predicting the outcome of a given PCR-changing operation on a given engine. On entry to the Predict Outcome function 1500 the corresponding current Engine Cert is searched for 1502. If it is not found, control is passed to the Mandatory Error Response 1506 and appropriate action is taken as described in the prior art. If it is found, the current Device Manufacturer PCRs described within the pcrSelection sub-field of the state field 310 of the Engine Cert are read from the Device Manufacturer's MTM 1508. The extend operation described by the Engine Cert is simulated 1510 by performing a composite hash calculation on the copied PCR index described by measurementPCRIndex 312 using the value measurementValue 314. The PCR copies then have their hash calculated and assigned 1512 to the digestAtRelease sub-field of the state field 310. The new state, along with a new label, is assigned to a copy of the previously-retrieved Engine Cert 1514. Next, using the Engine PCR Address Range 606 field a copy of the child's PCRs are made 1516. The operation passed into this function is simulated 1518 on the copy of the child's PCRs. To simulate the operation of the hooked function the description of the operation according to the prior art is consulted. For instance, according to the TCG Mobile Trusted Module Specification the MTM_VerifyRIMCertAndExtend API transforms the PCR indicated by the measurementPcrIndex field of the RIM Certificate passing in as an argument to the API by performing a cumulative hash operation on the existing value plus the value held within the measurementValue field. This transformation is applied to the copy of the child's PCRs retrieved at 1516. Then the hash of the resultant PCRs is calculated 1520. This new value is assigned to the copied Engine Cert's measurementValue field 1522, and the rimVersion field is incremented 1524. By using the MTM_InstallRIM API within the Device Manufacturer's MTM the copy Engine Cert has a signature added 1526 and the label of this certificate is added 1528 to the Predicted Engine Cert field 1302 of the Child Engine Table 1300. Finally, the new predicted Engine Cert is saved in the RIM Certificate Database 1530 and the routine completes 1532.

As described above, the prediction unit is configured to: a) copy the data to be integrity checked from the data storing unit to create a copy of the data; and b) perform the operation defined by the parameters to the prediction unit on the copy of the data.

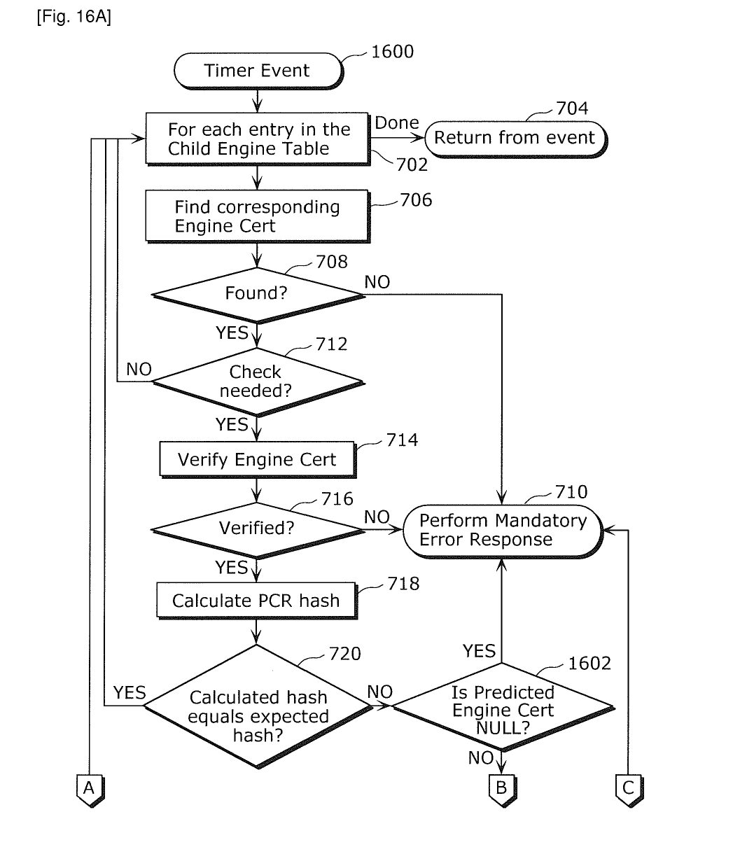

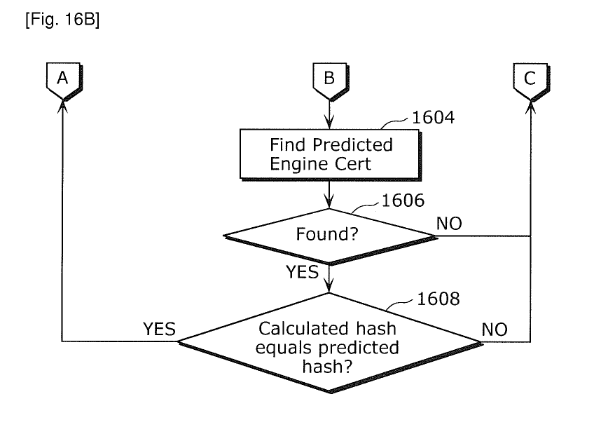

FIG. 16A and FIG. 16B illustrate the flow chart for processing a timer event within the Engine Checker. On the occurrence of a timer event 1600, the processing follows that described in FIG. 7. However, the additional processing for this embodiment takes place after the cryptographic hash of the child engine's PCRs are calculated then compared with the measurementValue field 314 within the Engine Cert 720. On a failure the Predicted Engine Cert field is checked 1602 and if it is set to NULL, then there is no change predicted, thus this is an unexpected error, so control is passed to the Mandatory Error Response 710 and appropriate action is taken as described in the prior art. Otherwise the relevant certificate is retrieved 1604. If this retrieval fails to find the named Engine Cert 1606, control is passed to the Mandatory Error Response 710 and appropriate action is taken as described in the prior art. Otherwise, the PCR hash calculated at 718 is compared with the predicted hash 1608 stored within the Engine Cert illustrated in FIG. 15. If the new actual hash does not match the predicted hash control is passed to the Mandatory Error Response 710 and appropriate action is taken as described in the prior art, otherwise the predicted change has happened so control is passed back to the top of the event handler so that the next entry in the Child Engine Table may be processed 702.

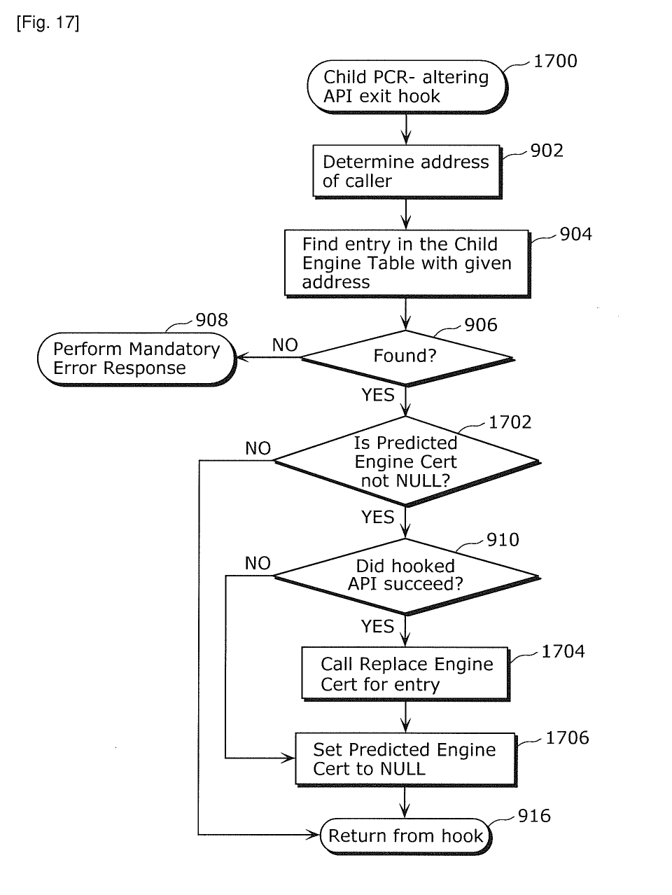

FIG. 17 illustrates the flow chart for processing a call from a child engine into the Device Manufacturer's engine from the exit point of a hooked routine as installed at 516. After entering the hook 1700, the processing initially follows that described in FIG. 9, with the address of the caller being determined 902. According to a preferred implementation the calling address is passed in as an argument, but one ordinarily-skilled in the art will see that other methods such as examining the call stack to determine the entry point are possible. This address is used to look up the Child Engine Table's Engine Address Range 604 field to find the row with an address range within which the caller's address falls 904. If no match is found 906, then control is passed to the Mandatory Error Response 908 and appropriate action is taken as described in the prior art. Next, the Predicted Engine Cert field 1302 is checked 1702, and if it is NULL, there is no predicted Engine Cert, so the routine can return 916. If there is a Predicted Engine Cert, the return code from the hooked API is checked to see if it succeeded 910. If it did, then the child engine's PCRs have changed, so code to replace the Engine Cert with the Predicted Engine Cert 1704 for this entry in the Child Engine Table is called. After this call, or if the hooked API failed, the current entry in the Child Engine Table needs to get the Predicted Engine Cert field set to NULL 1706 to indicate the prediction is no longer valid. The code can now return to the caller 916.

As described above, when a request is received from executing code stored within the program storage unit to modify the data to be integrity-checked, the Stakeholder MTM 128, which is an example of a data modification unit, is configured to: a) disable the failure handling unit; b) request the prediction unit to predict the outcome of the request; c) request the integrity check value calculating unit to calculate a predicted integrity check value for the predicted outcome; d) perform requested modification of the data in the data storing unit; e) request the integrity check value calculating unit to calculate a new integrity check value for the data to be integrity-checked; f) request the failure handling unit to record an error, in the case where the new integrity check value does not equal the predicted integrity check value; g) request the integrity-checking unit to update the stored integrity check value with new integrity check value; and h) re-enable the failure handling unit.

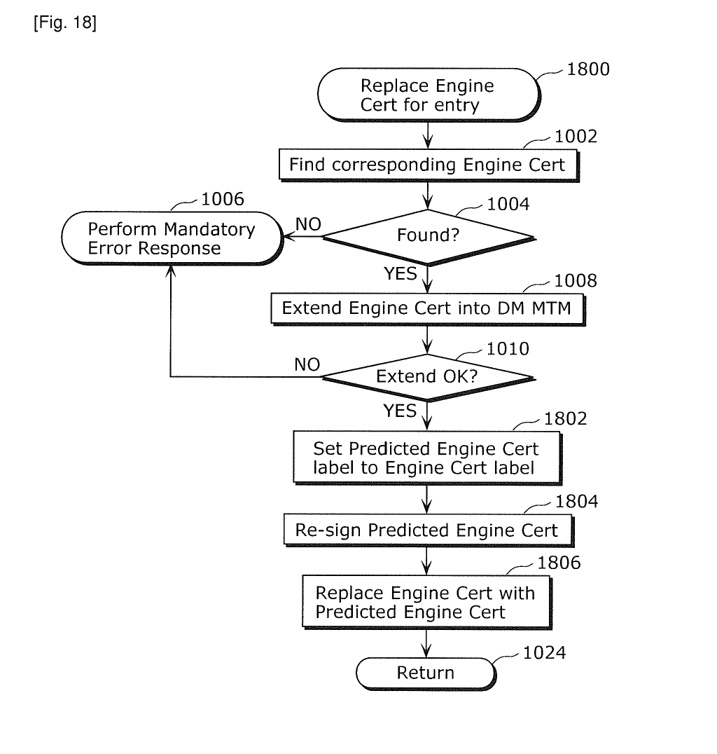

FIG. 18 illustrates the flow chart for replacing the Engine Cert with a passed-in Predicted Engine Cert 1800 for a given entry row in the Child Engine Table 1300. As described for FIG. 10, the name of the Engine Cert for each row is generated from the Engine ID field 602, and this name is used to find the corresponding Engine Cert 1002 from within the RIM Certificate Database. If the certificate is not found 1004, then control is passed to the Mandatory Error Response 1006 and appropriate action is taken as described in the prior art. Otherwise, the Engine Cert is extended into the Device Manufacturer's MTM 1008 using the MTM_VeritfyRIMCertAndExtend API. If the operation fails, then control is passed to the Mandatory Error Response 1006 and appropriate action is taken as described in the prior art. Otherwise, the label field 302 within the passed-in Predicted Engine Cert is set 1802 to the label field of the Engine Cert retrieved at 1002, and the Device Manufacturer's MTM is requested to sign the updated Predicted Engine Cert 1804 using the MTM_InstallRIM API as described in the prior art. Finally, the Predicted Engine Cert replaces the previous Engine Cert within the RIM Certificate Database 1806, and control is passed back to the caller 1024.

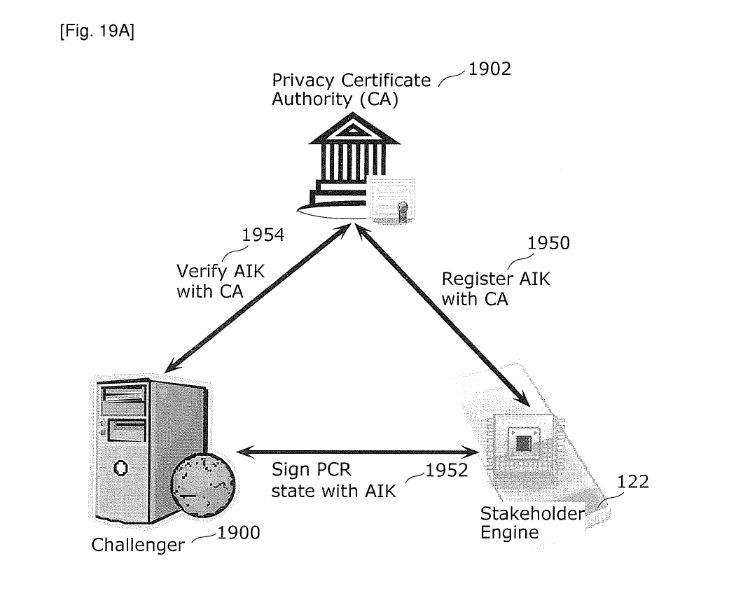

FIG. 19A illustrates an overview of remote attestation according to the prior art. The three actors are a Privacy Certificate Authority 1902 that is responsible for issuing and verifying key certificates, the Stakeholder Engine 122 on the mobile device, and the Challenger 1900 that will request attestation from the Stakeholder Engine 122. The three key interactions between these actors are first, the Stakeholder Engine 122 registers an AIK Cert 1950 that it generates itself with the Privacy Certificate Authority 1902, then in response to a remote attestation request from the Challenger 1900 returns its PCR state signed with the AIK, and the AIK Certificate 1952 certified by the Privacy Certificate Authority 1902. Finally the Challenger 1900 verifies the AIK Certificate 1954 with the Privacy Certificate Authority 1902.

FIG. 19B illustrates in detail remote attestation according to the prior art. The four actors are the remote service that acts as a Challenger 1900, a Privacy Certificate Authority 1902, the Stakeholder's Trusted Software Stack (TSS) or Abstraction Layer, etc, on the device 1904, and the Stakeholder's MTM on the device 1906. The TSS is part of the Stakeholder Services 126 and 136 that deals with the interface between applications and a trusted module as described in the prior art. Note that the Stakeholder Engine 122 from FIG. 19A has been split into two separate components 1904 and 1906 to enable further details of the behaviour of the mobile device to be described. The Challenger 1900 may be a server providing a service that the device wishes to use, or it may be another peer device, or it may be a peripheral such as a smart card, or any other form of computing device, with or without trusted components. There are two phases—first Provisioning 1908 where the Stakeholder creates an AIK (Attestation Identity Key) and registers it with a Privacy CA, and second the Attestation itself 1910. As described in the prior art, an AIK is a key owned by a trusted module (TPM or MTM) with a publically-known certificate that can be used as proof that an attestation request has indeed been handled by a certified trusted module. Once a device has finished provisioning an AIK, it can support multiple attestation requests. The provisioning process happens at times such as first activation of a device, at the request of a program that wishes to perform attestation but detects the lack of an AIK, or from a request by an application started explicitly by the user to get the device “Attestation-Ready”. Once the process for creating an AIK within the Stakeholder TSS 1904 is called, first the TSS requests that the MTM creates an AIK 1912 using the TPM_MakeIndentity API as described in the prior art. The TSS then creates a suitable AIK certificate 1914 that describes this key in X.509 or other format, and delivers the certificate to the Privacy CA 1916 which will verify the key structure and the authority of the device and countersign the certificate and return it to the Stakeholder TSS. To perform remote attestation, a Challenger who is aware of how to establish a communication channel to the Stakeholder TSS first randomly generates a nonce 1918 and sends the nonce in an attestation request 1920 to the Stakeholder. The TSS requests that the MTM signs a quote of a subset of PCRs within the MTM along with the nonce using the AIK 1922, using the TPM_Quote2 API as described in the prior art. The quote result and the AUK certificate for the signing key generated in 1914 are returned to the challenger 1924. The challenger verifies that the signature was generated using the returned AIK 1926, and verifies with the Privacy CA 1928 that the AIK is indeed a validly-signed AIK.

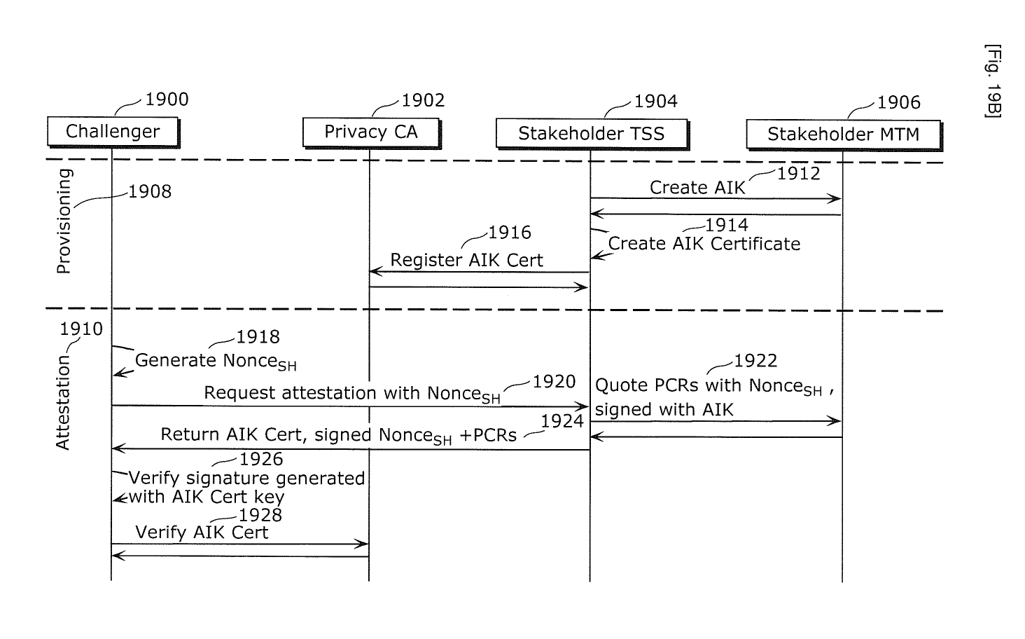

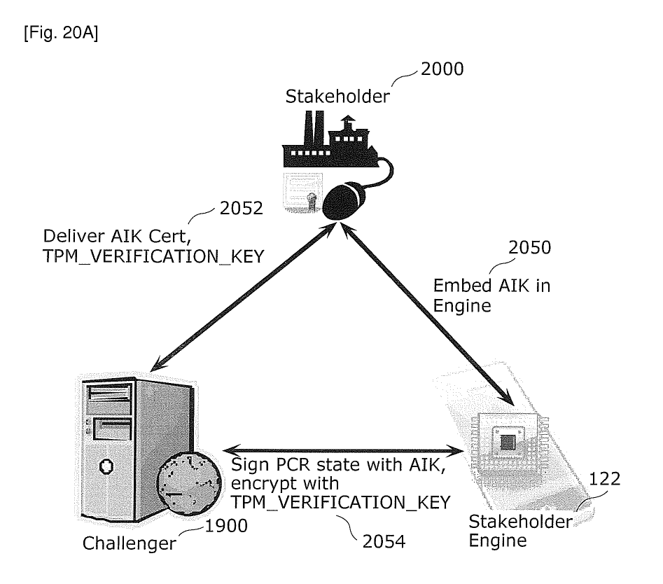

FIG. 20A illustrates an overview of remote attestation according to the present invention. The three actors are a Stakeholder 2000 that is responsible for creating the AIK and its Certificate and the TPM_VERIFICATION_KEY key certificates, the Stakeholder Engine 122 on the mobile device, and the Challenger 1900 that will request attestation from the Stakeholder Engine 122. The Challenger 1900 is an example of a challenger device including a challenger unit configured to issue a remote attestation challenge. The challenger unit is configured to issue a challenge to the attestation unit using public portion of the attestation key. The three key interactions between these actors are first, the Stakeholder 2000 creates an MK and embeds it 2050 into the Stakeholder Engine 122. The Stakeholder 2000 is an example of a key issuing device including a key issuing unit configured to issue an attestation key. The key issuing unit is configured to issue an attestation key to the challenger. In a preferred implementation, the embedding process takes place during manufacture of the device. Next, the Stakeholder 2000 delivers its AIK Certificate and a TPM_VERIFICATION_KEY 2052 to the Challenger 1900, and finally the Stakeholder Engine 122 in response to a remote attestation request returns to the Challenger 1900 its PCR state signed with the AIK and encrypted with the TPM_VERIFICATION_KEY 2054 sent from the Challenger 1900. The Stakeholder Engine 122 is an example of an attestation device including an attestation unit configured to respond to challenges. The attestation unit is configured to perform attestation based on the challenger's challenge, and to return an attestation result encrypted with the public portion of the attestation key to the challenger.

FIG. 20B illustrates in detail remote attestation according to the present invention.

The lour actors are the remote service that acts as a Challenger 1900, an off-device Stakeholder server 2000, the Stakeholder's Trusted Software Stack (or Abstraction Layer, etc) on the device 1904, and the Stakeholder's MTM on the device 1906. Note that the Stakeholder Engine 122 from FIG. 20A has been split into two separate components 1904 and 1906 to enable further details of the behaviour of the mobile device to be described. The Challenger 1900 may be a server providing a service that the device wishes to use, or it may be another peer device, or it may be a peripheral such as a smart card, or any other form of computing device, with or without trusted components. The stakeholder may be either the Device Manufacturer or another stakeholder as defined by the Multi-Stakeholder Model. There are three phases—first, Manufacturing where the Stakeholder creates an AIK (Attestation Identity Key) and embeds it on the device 2002, second, Provisioning 2004 where the Stakeholder creates a TPM_VERIFICATION_KEY as described by the prior art and delivers it to the Challenger, and third, the Attestation itself 2006. It should be noted that the public portion of the attestation key (AIK) includes evidence that the attestation key is a key known to the attestation device. The public portion of the attestation key is validated by the attestation unit. Furthermore, the evidence that the attestation key is known to the attestation device includes a reference to a second key known to the attestation device. According to the prior art, a Privacy Certificate Authority is not needed, although in another preferred embodiment of the invention the AIK certificate is registered with a Privacy CA. Once a Stakeholder has finished manufacturing a device with an AIK, it can support provisioning of TPM_VERIFICATION_KEY structures to one or more Challengers. Once a stakeholder has finished provisioning a TPM_VERIFICATION_KEY to a Challenger, the Challenger may perform multiple attestation requests. The manufacturing process happens at times such as during hardware manufacture or other process before the device is released to a customer. The provisioning process happens at times such as when a third party requests to a stakeholder that it wishes to perform attestation challenges on a stakeholder's device. At manufacture time 2002 the stakeholder creates an AIK and a matching certificate 2008 and embeds the private portion of the AIK 2010 within the stakeholder's MTM. For hardware MTMs this may be physically writing information into secure memory, and for software MTMs this may be injecting data into an executable and signing it. For provisioning 2004 a TPM_VERIFICATION_KEY 2100 as defined by the Mobile Trusted Module Specification is created 2012, derived from the RVAI. The usageFlags 2104 is set to TPM_VERIFICATION_KEY_USAGE_REMOTE_ATTESTATION to indicate the use of this key for encrypting attestation requests. In a preferred implementation, the keyAlgorithm field 2112 indicates the data is a key for a symmetric encryption algorithm thus there is no private key portion; in another preferred implementation, a public key is used, thus there is also a private key portion. The TPM_VERIFICATION_KEY 2100 structure is signed using the indicated parent key which in a preferred implementation is confidential to the stakeholder. The created AIK certificate, TPM_VERIFICATION_KEY, and, if present, the private key for the TPM_VERIFICATION_KEY are delivered 2014 to the third party who will act as an attestation challenger. As the data being sent allows the receiver to understand the results of an attestation request, security of the data in transit must be maintained. For electronic transfer, an SSL-based system will ensure protection of the data in motion; for physical transfer, the data on the transfer medium may be encrypted with a key agreed through a separate out-of-band channel. To perform remote attestation 2006, a Challenger who is aware of how to establish a communication channel to the Stakeholder TSS first randomly generates a nonce 2016 and sends the nonce and the previously-provisioned TPM_VERIFICATION_KEY in an attestation request 2018 to the Stakeholder. If the keyAlgorithm 2112 is symmetric then one ordinarily-skilled in the art will see that the communication channel needs to be protected, such as by using an SSL-based scheme. The TSS requests that the MTM signs a quote of a subset of PCRs within the MTM along with the nonce using the MK 2020 embedded at manufacturing time, using the TPM_Quote2 API as described in the prior art. Next the TPM_VERIFICATION_KEY delivered from the challenger is loaded 2022 into the Stakeholder's MTM and verified by checking that the process succeeded. The result from the quote operation 2020 is encrypted 2024 within the stakeholder's TSS as a TPM_VERIFICATION_KEY cannot be used by the MTM for general-purpose encryption, and sent back to the challenger 2026. The challenger decrypts the returned message 2028 then verifies 2030 that the signed message was signed by the previously-provisioned AIK Cert key. If the verification succeeds the challenger has now remotely attested to the state of the stakeholder's MTM's PCRs. It should be noted that the attestation challenge issued by the challenger unit further includes an indicator describing a subset of attestation information to return.

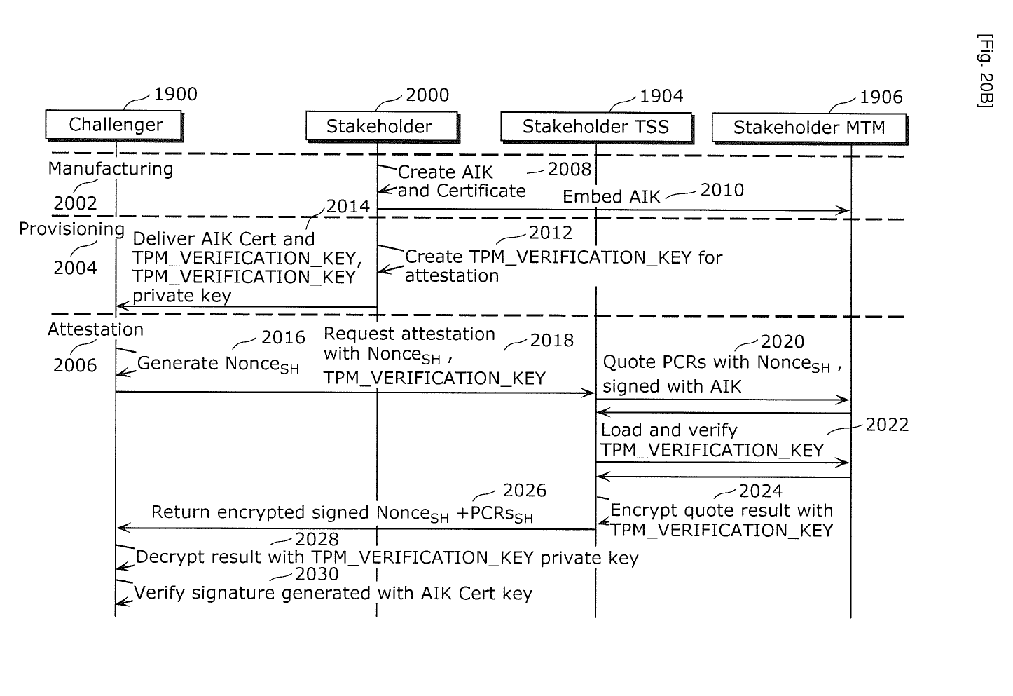

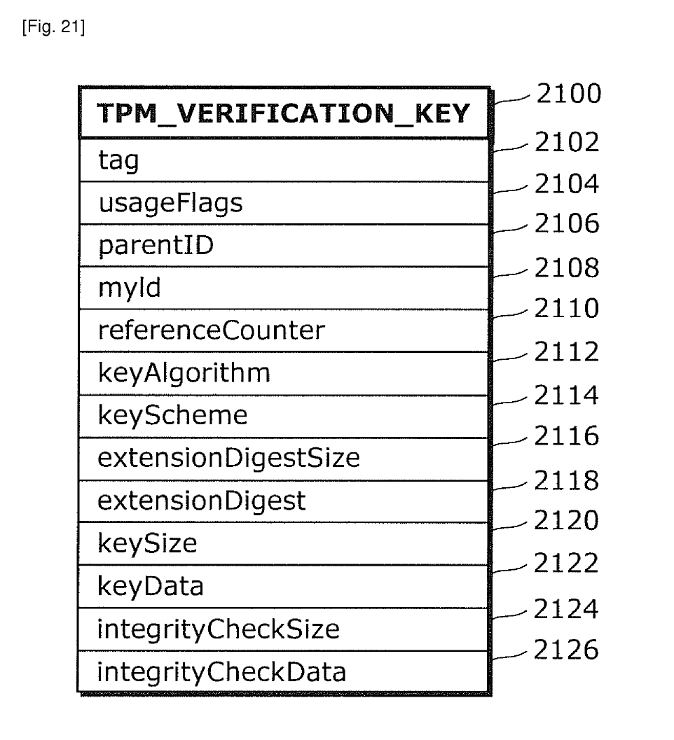

FIG. 21 illustrates the structure of the TPM_VERIFICATION_KEY according to the TCG Mobile Trusted Module Specification prior art. First, the tag 2102 holds TPM_TAG_VERIFICATION_KEY, usageFlags 2104 has the TPM_VERIFICATION_KEY_USAGE_REMOTE_ATTESTATION bit set, defined by the present invention to be 0x1000. parentId 2106, myId 2108, referenceCounter 2110, keyAlgorithm 2112, and keyScheme 2114 are as described by the prior art. According to the present invention, no extension data is defined, so extensionDigestSize 2116 and extensionDigest 2118 may be zero and empty respectively. Finally, the remaining fields of keySize 2120, keyData 2122, integrityCheckSize 2124 and integrityCheckData 2126 are also as described by the prior art. According to the preferred embodiment, the parentId 2106 is not the root key but an intermediate key, allowing the stakeholder to provision many TPM_TAG_VERIFICATION_KEYs but revoke them all by revoking the intermediate TPM_TAG_VERIFICATION_KEY as described by the prior art.

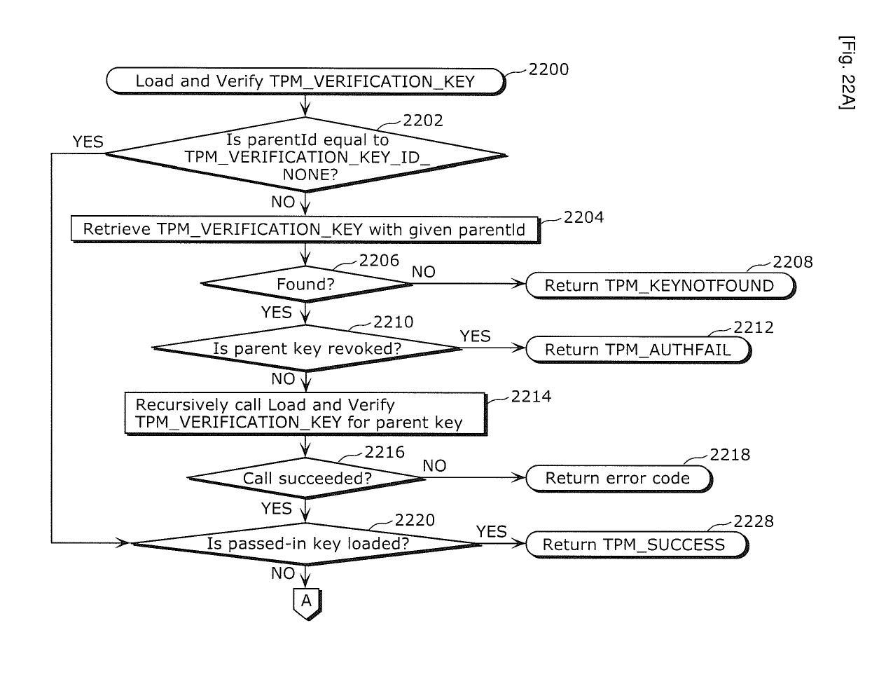

FIG. 22A and FIG. 22B illustrate loading and verifying a TPM_VERIFICATION_KEY according to the present invention. This figure illustrates in detail the step 2022 in FIG. 20. The entry point of this recursive routine requires the key to be loaded as a parameter 2200. First, the parentId field 2106 is checked to see if it holds TPM_VERIFICATION_KEY_ID_NONE 2202 indicating that this key is the root key. If it is not the root key, then the routine attempts to retrieve the TPM_VERIFICATION_KEY with the given parentId 2204. According to the prior art, the Stakeholder is required to manage the TPM_VERIFICATION_KEYs present on the system. If the parent key is not found 2206, then an error has occurred and the routine returns a TPM_KEYNOTFOUND error code 2208. Furthermore, according to the prior art, the Stakeholder is also required to manage the revocation status of these keys, so if the key is found its revocation status also needs to checked 2210. If the key is determined to have been revoked, the routine returns a TPM_AUTHFAIL error code 2212. In this manner, the key issuing unit is further configured to issue a revocation certificate for the attestation key. In addition, the attestation unit is configured to invalidate the attestation key on reception of the revocation certificate. Next a recursive call is made to the routine 2214 so that the parent key may be loaded and verified. Specifically, the attestation unit is configured to validate the public portion of the attestation key's parent key. For example, the attestation unit is further configured to attest to values of a set of information items that represent the state of the attestation unit. Here, each item includes a numeric value describing an aspect of the attestation unit. Specifically, each item is a Platform Configuration Register (PCR) as defined by the Trusted Computing Group. If the parent loading and verification failed 2216, the routine returns the failing error code 2218. Otherwise, the TPM_VERIFICATION_KEY passed into the function is checked to see if it is already loaded into the MTM 2220. Techniques well-known in the art, such as for a preferred embodiment a map of myId field 2108 to TPM_VERIFICATION_KEY_HANDLE are employed to record the loaded keys. If the key is not already loaded, the MTM_LoadVerificationKey API is called 2222 to perform the loading and verification process. If the loading failed 2224, the routine returns the failing error code 2218. Otherwise, the TPM_VERIFICATION_KEY_HANDLE returned is recorded 2226, by, in a preferred embodiment, adding the myId field 2108 and TPM_VERIFICATION_KEY_HANDLE pair to a map of loaded keys. Finally, the routine returns a TPM_SUCCESS code 2228 to the caller to either continue the loading of child keys in the case of a recursive call, or to report to the attestation process that the key hierarchy has been verified in the case of the top-level call.

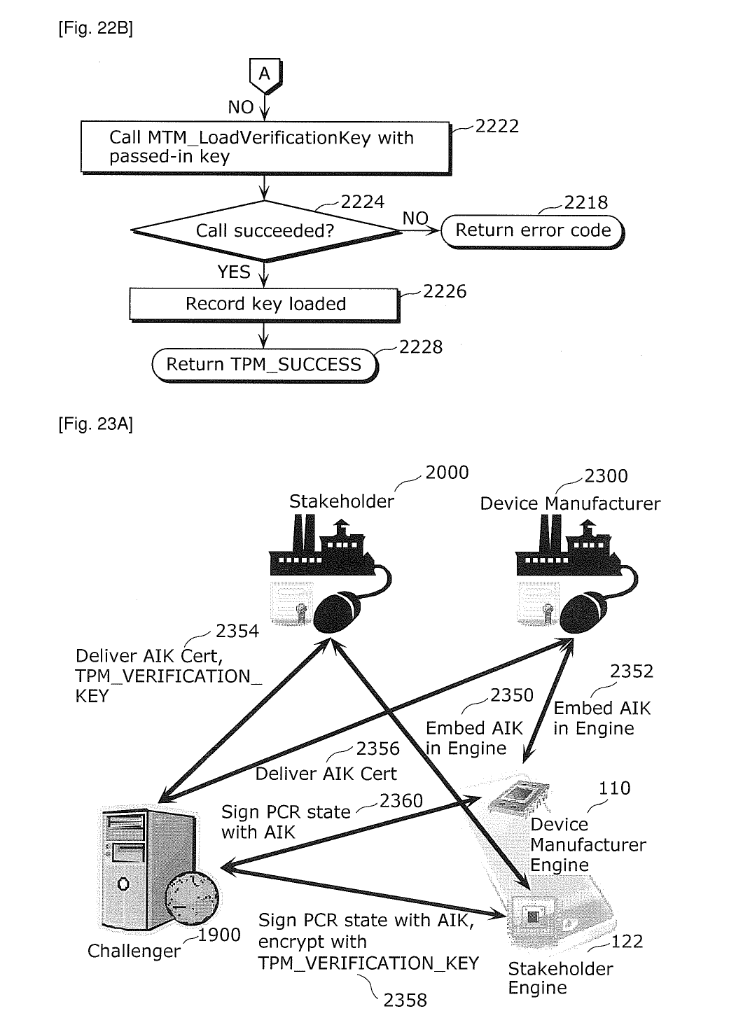

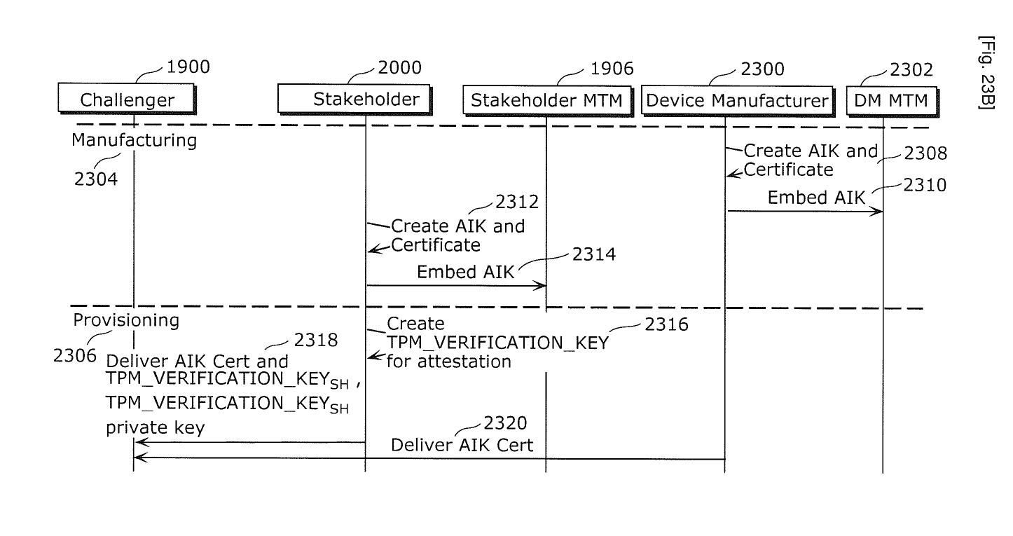

FIG. 23A illustrates an overview of remote multi-stake attestation according to the present invention. The five actors are a Stakeholder 2000 that is responsible for creating the AIK and its Certificate and the TPM_VERIFICATION_KEY key certificates for the Stakeholder Engine 122 on the mobile device, a Device Manufacturer 2300 that is responsible for creating the AIK and its Certificate for the Device Manufacturer Engine 110 on the mobile device, and the Challenger 1900 that will request attestation from the two engines 122 and 110. Specifically, the Stakeholder 2000 and the Device Manufacturer 2300 are examples of a key issuing device including a key issuing unit configured to issue an attestation key. Furthermore, the Challenger 1900 is an example of a challenger device including a challenger unit configured to issue remote attestation challenges. The attestation device includes the Stakeholder Engine 122 which is an example of a first attestation unit configured to respond to challenges, and the Device Manufacturer Engine 110 which is an example of a second attestation unit configured to respond to challenges. Furthermore, the attestation device further includes a connector unit configured to allow the first attestation unit to communicate with the second attestation unit. The key interactions between these actors are first, the Stakeholder 2000 creates an AIK and embeds it 2350 into the Stakeholder Engine 122, and the Device Manufacturer 2300 creates an AIK and embeds it 2352 into the Device Manufacturer Engine 110. In a preferred implementation, the embedding processes take place during manufacture of the device. Next, the Stakeholder 2000 delivers its AIK Certificate and a TPM_VERIFICATION_KEY 2354 to the Challenger 1900 and the Device Manufacturer 2300 delivers its AIK Certificate 2356 to the Challenger 1900. Finally the Stakeholder Engine 122 in response to a remote attestation request returns to the Challenger 1900 its PCR state signed with the AIK and encrypted with the TPM_VERIFICATION_KEY 2358 sent from the Challenger 1900. In short, the key issuing unit is configured to issue an attestation key to the challenger, and the challenger unit is configured to issue a challenge to the Stakeholder Engine 122, which is an example of the first attestation unit, using a public portion of the attestation key. The first attestation unit is configured to perform first attestation based on the challenger's challenge, and to return a first attestation result encrypted with the public portion of the attestation key to the challenger. Then, the Device Manufacturer Engine 110 in response to a remote multi-stakeholder attestation request returns to the Challenger 1900 its PCR state signed with the AIK 2360. In short, the connector unit is configured to communicate the first attestation result from the first attestation unit to the Device Manufacturer Engine 110 which is an example of the second attestation unit, the challenger unit is configured to issue a challenge to the second attestation unit, and the second attestation unit is configured to perform second attestation based on the challenger's challenge and the first attestation result communicated through the connector unit and to return a second attestation result to the challenger.

FIG. 23B illustrates in detail manufacturing and provisioning in preparation for remote multi-stakeholder attestation according to the present invention, where the challenger wishes to query the state of a stakeholder's MTM then confirm the result with the Device Manufacturer's MTM. The five actors are the remote service that acts as a Challenger 1900, an off-device Stakeholder server 2000, the Stakeholder's MTM on the device 1906, an off-device Device Manufacturer server 2300, and the Device Manufacturer's MTM on the device 2302. At manufacture time 2304 the Device Manufacturer creates an AIK and a matching certificate 2308 and embeds the private portion of the AIK 2310 within the Device Manufacturer MTM. It should be noted that the public portion of the attestation key (AIK) includes evidence that the attestation key is a key known to the attestation device. The Stakeholder Engine 122, which is an example of the first attestation unit, is configured to validate the public portion of the attestation key. Furthermore, the evidence that the attestation key is known to the attestation device includes a reference to a second key (TPM_VERIFICATION_KEY) known to the attestation device. For hardware MTMs this may be physically writing information into secure memory, and for software MTMs this may be injecting data into an executable and signing it. Next the stakeholder creates an AIK and a matching certificate 2312 and embeds the private portion of the AIK 2314 within the stakeholder's MTM. For hardware MTMs this may be physically writing information into secure memory, and for software MTMs this may be injecting data into an executable and signing it. For provisioning 2306 a TPM_VERIFICATION_KEY 2100 as defined by the Mobile Trusted Module Specification is created 2316, derived from the RVAI. The usageFlags 2104 is set to TPM_VERIFICATION_KEY_USAGE_REMOTE_ATTESTATION to indicate the use of this key for encrypting attestation requests. In a preferred implementation, the keyAlgorithm 2112 is a symmetric key thus there is no private key portion; in another preferred implementation, a public key is used, thus there is also a private key portion. The TPM_VERIFICATION_KEY 2100 structure is signed using the indicated parent key which in a preferred implementation is confidential to the stakeholder. The created AIK certificate, TPM_VERIFICATION_KEY, and, if present, the private key for the TPM_VERIFICATION_KEY are delivered 2318 to the third party who will act as an attestation challenger. As the data being sent allows the receiver to understand the results of an attestation request, security of the data in transit must be maintained. For electronic transfer, an SSL-based system will ensure protection of the data in motion; for physical transfer, the data on the transfer medium may be encrypted with a key agreed through a separate out-of-band channel. For the Device Manufacturer, only the AIK Cert is provisioned 2320, because as illustrated below, a TPM_VERIFICATION_KEY for the Device Manufacturer's MTM is not required. However, one ordinarily-skilled in the art will realise that an alternative embodiment may use a TPM_VERIFICATION_KEY for attestation to the Device Manufacturer's MTM.

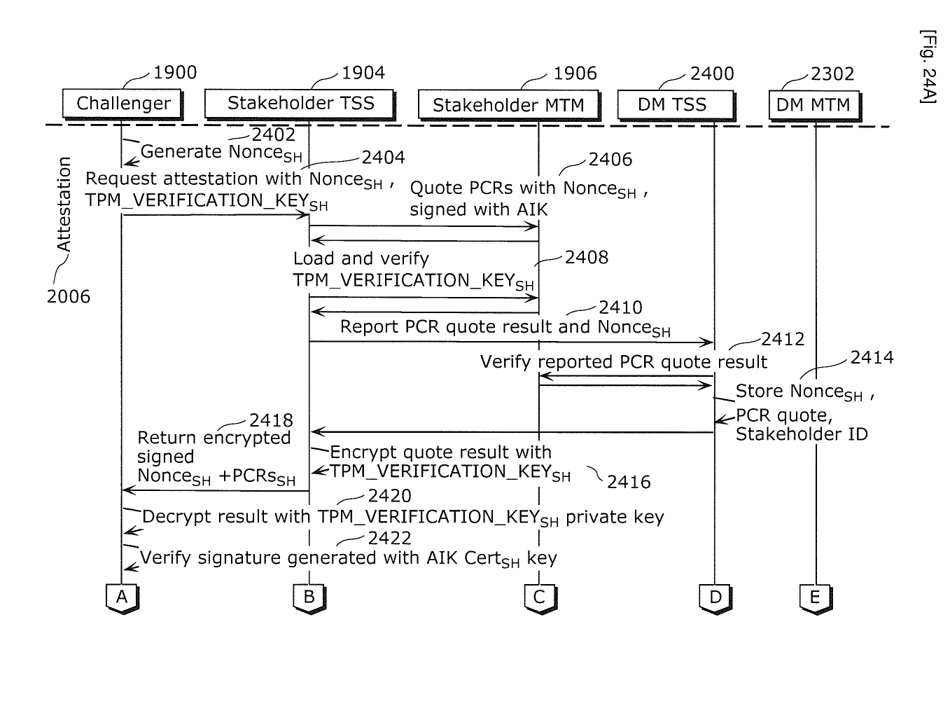

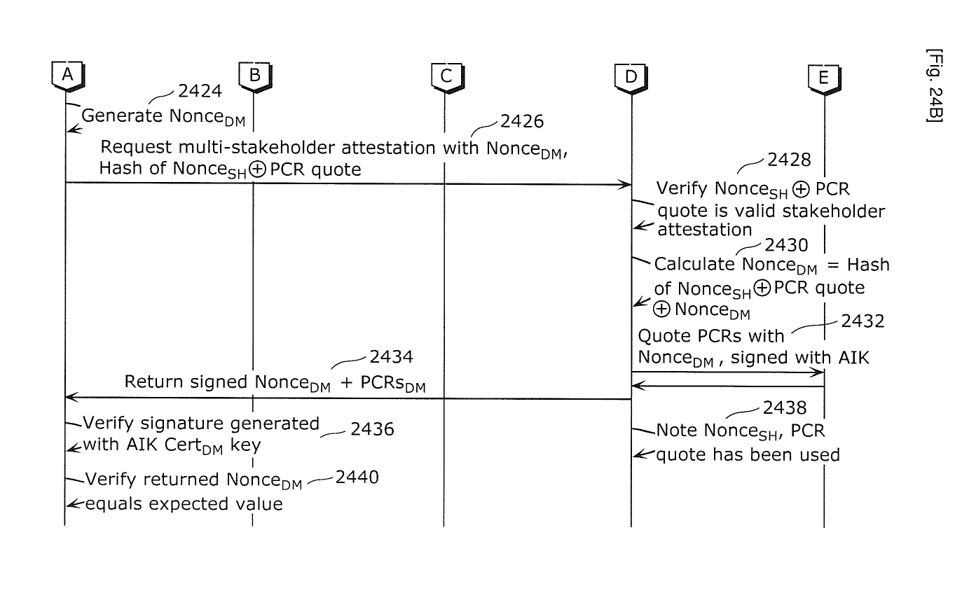

FIGS. 24A and 24B illustrate in detail remote multi-stakeholder attestation according to the present invention, where the challenger wishes to query the state of a stakeholder's MTM then confirm the result with the Device Manufacturer's MTM. The five actors are the remote service that acts as a Challenger 1900, the Stakeholder's Trusted Software Stack on the device 1904, the Stakeholder's MTM on the device 1906, the Device Manufacturer's Trusted Software Stack on the device 2400, and the Device Manufacturer's MTM on the device 2302. Note that the Stakeholder Engine 122 from FIG. 23A has been split into two separate components 1904 and 1906 and the Device Manufacturer Engine 110 from FIG. 23A has been split into two separate components 2400 and 2302 to enable further details of the behaviour of the mobile device to be described. The Stakeholder server 2000 and Device Manufacturer server 2300 illustrated in FIG. 23 do not play a role in the actual attestation, so are not illustrated in this figure. The remote multi-stakeholder attestation 2006 starts in FIG. 24A when a Challenger 1900 who is aware of how to establish a communication channel to the Stakeholder TSS 1904 and the underlying Device Manufacturer TSS 2400 randomly generates a stakeholder nonce 2402 and sends the nonce and the previously-provisioned stakeholder TPM_VERIFICATION_KEY in an attestation request 2404 to the Stakeholder. It should be noted that the challenge to the first attestation unit issued by the challenger unit further includes an indicator describing a subset of attestation information to return. If the keyAlgorithm 2112 field indicates that the key is symmetric then one ordinarily-skilled in the art will see that the communication channel needs to be protected, such as by using an SSL-based scheme. The Stakeholder TSS requests that the Stakeholder MTM 1906 signs a quote of a subset of PCRs within the MTM along with the stakeholder nonce using the stakeholder's AIK 2406 embedded at manufacturing time, using the TPM_Quote2 API as described in the prior art. Next the stakeholder TPM_VERIFICATION_KEY delivered from the challenger is loaded 2408 into the Stakeholder MTM and verified by checking that the process succeeded. Specifically, the first attestation unit is configured to validate the first key's parent key. For example, the first attestation unit is further configured to attest to values of a set of information items that represent the state of the first attestation unit. Here, each of the items that represent the state of the first attestation unit includes a numeric value describing an aspect of the attestation unit. Specifically, each of the items that represent the state of the first attestation unit is a Platform Configuration Register (PCR) as defined by the Trusted Computing Group. The Stakeholder TSS notifies the Device Manufacturer TSS 2400 of the result 2406 of the quote operation 2408 and the stakeholder nonce 2410. The Device Manufacturer TSS then verifies the reported quote result 2412 and stores a concatenation of the stakeholder nonce and the stakeholder's PCR quote, and an identifier representing the stakeholder 2414; the details of these operations are described below. Next, the result from the quote operation 2406 is encrypted 2416 within the stakeholder's TSS as a TPM_VERIFICATION_KEY cannot be used by the MTM for general-purpose encryption, and sent back to the challenger 2418. The challenger decrypts the returned message 2420 then verifies 2422 that the signed message was signed by the previously-provisioned stakeholder AIK Cert key. If the verification succeeds the challenger has now remotely attested to the state of the stakeholder's MTM's PCRs and is ready to perform remote multi-stakeholder attestation on the Device Manufacturer's MTM as illustrated in FIG. 24B.

The Challenger 1900 next randomly generates a device manufacturer nonce 2424 and sends the nonce and a cryptographic hash of the concatenation of the previously-generated stakeholder nonce 2402 and the resultant PCR quote data 2406 as a remote multi-stakeholder attestation request 2426. It should be noted that the challenge to the second attestation unit issued by the challenger unit further includes an indicator describing a subset of attestation information to return. In a preferred embodiment, the cryptographic hash routine is SHA1. The Device Manufacturer TSS verifies that this cryptographic hash represents a previously-performed valid stakeholder attestation 2428; the details of this operation are described below. In short, the second attestation unit is configured to attest to values of a set of information items that represent the state of the second attestation unit. Here, each of the items that represent the state of the second attestation unit includes a numeric value describing an aspect of the attestation unit. Specifically, each of the items that represent the state of the second attestation unit is a Platform Configuration Register (PCR) as defined by the Trusted Computing Group. If the verification fails, in a preferred embodiment the Device Manufacturer TSS terminates the attestation session with an appropriate error. Next, the Device Manufacturer TSS calculates a new Device Manufacturer nonce 2430 by evaluating a cryptographic hash of the concatenation of previously-generated stakeholder nonce 2402, the resultant PCR quote data 2406, and the device manufacturer nonce 2424. This new nonce is passed along with a handle to the Device Manufacturer's AIK embedded at manufacturing time to the Device Manufacturer MTM 2302 using the TPM_Quote2 API as described in the prior art to produce a signed quote 2432 of a subset of PCRs within the MTM along with the nonce. This signed new nonce plus PCR quote data is returned 2434 to the Challenger, who can verify the signature using the MK Certificate previously provisioned by the Device Manufacturer 2436. By also verifying the returned new nonce 2440 by performing the same calculation locally as the Device Manufacturer TSS performed at 2430 the Challenger also has proof that the Stakeholder TSS correctly informed the Device Manufacturer TSS of the nonce the Challenger sent at 2404. Finally, since the Device Manufacturer has successfully completed the remote multi-stakeholder attestation protocol, the Device Manufacturer TSS notes that the stakeholder nonce and PCRs previously recorded at 2414 have been used 2438; the details of this operation are described below.

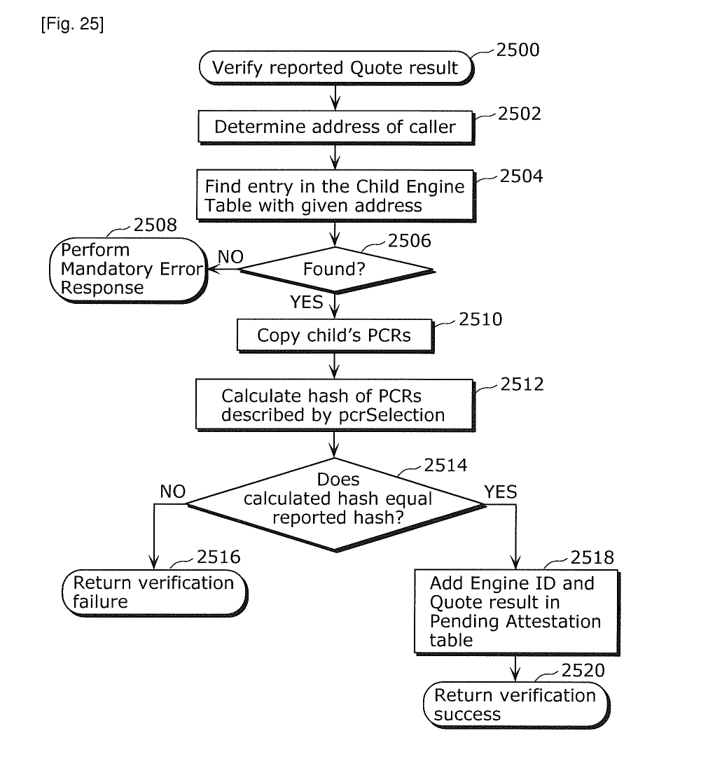

FIG. 25 illustrates verifying a reported quote result from a child stakeholder engine according to the present invention, detailing the processing for step 2412. In other words, the second attestation unit verifies the communicated first attestation result. Specifically, the second attestation unit may directly access the first attestation unit's attestation information. The TPM_PCR_INFO_SHORT structure as defined by the prior art passed from the child stakeholder's TSS is a parameter to the function to verify the reported quote result 2500. First of all the address of the caller is determined 2502. According to a preferred implementation the canine address is passed in as an argument, but one ordinarily-skilled in the art will see that other methods such as examining the call stack to determine the entry point are possible. This address is used to look up the Child Engine Table's Engine Address Range 604 field to find the row with an address range within which the caller's address falls 2504. If no match is found 2506, then control is passed to the Mandatory Error Response 2508 and appropriate action is taken as described in the prior art. Otherwise, using the Engine PCR Address Range field 606 data the child PCRs are copied from the child MTM's address space 2510, and using the pcrSelection field within the passed-in TPM_PCR_INFO_SHORT the hash of copied PCRs is evaluated 2512. If this calculated hash does not equal the digestAtRelease field within the passed-in TPM_PCR_INFO_SHORT 2514 then the routine returns a value to indicate failure 2516, otherwise if the hashes do match, the Engine ID field 602 from the current row of the Child Engine Table and the passed-in TPM_PCR_INFO_SHORT parameter are added to the Pending Attestation Table 2518 and the routine returns a value to indicate success 2520. One ordinarily-skilled in the art will see that alternative methods for verification, including no verification at all, may also be employed, as long as in the successful execution case the parameters are added to the Pending Attestation Table 2518.

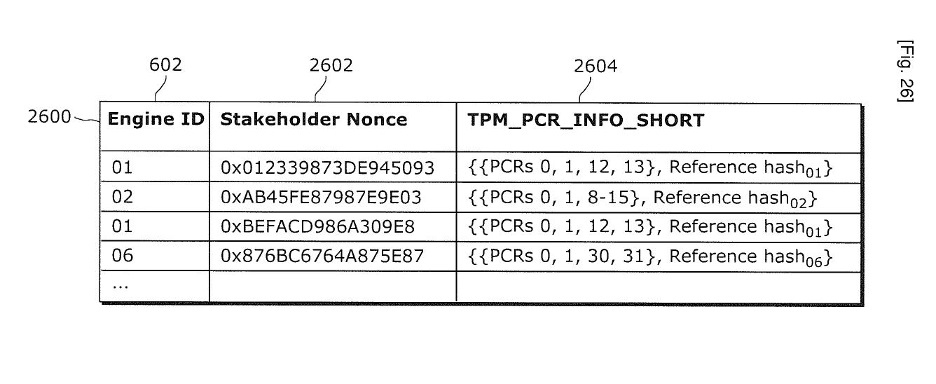

FIG. 26 illustrated the Pending Attestation Table 2600 that holds the currently in-progress attestation requests. First, the Engine ID field 602 contains a two character code that describes the stakeholder engine that has a pending attestation request, next the Stakeholder Nonce field 2602 holds the nonce the challenger supplied to the attestation routine, and finally the TPM_PCR_INFO_SHORT field 2604 holds the verified attestation value that the Stakeholder TSS reported to the Device Manufacturer TSS. Note that since the Stakeholder Nonce field 2602 is a random value, the same Engine ID may appear more than once in the table without causing any problems.

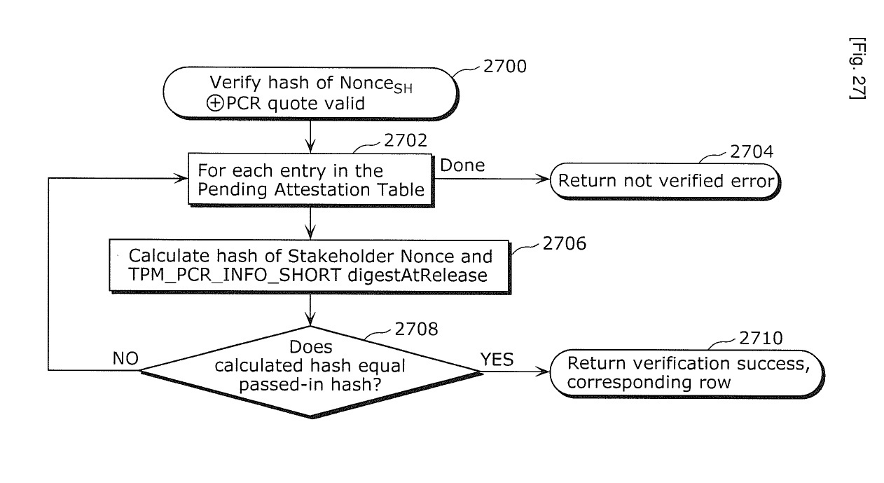

FIG. 27 illustrates verifying that a remote multi-stakeholder attestation request to a Device Manufacturer TSS contains a valid child stakeholder value. Passed into the routine is a value supplied by a challenger that claims to be the cryptographic hash of the nonce used with the child stakeholder and the PCR values reported by the child stakeholder for a pending multi-stakeholder attestation 2700. For each row 2702 within the Pending Attestation Table 2600 the hash of the Stakeholder Nonce field 2602 concatenated with the digestAtRelease from the TPM_PCR_INFO_SHORT field 2604 is calculated 2706 and compared with the passed-in value 2708. If the two values are equal, then the passed-in value does represent a pending multi-stakeholder attestation request, so the Stakeholder Nonce field 2602 and the TPM_PCR_INFO_SHORT field 2604 are returned to the caller along with a status flag to indicate success 2710. If on the other hand all rows are checked and no match is found, then the passed-in value does not represent a pending multi-stakeholder attestation request, so a status flag to indicate failure is returned instead 2704.

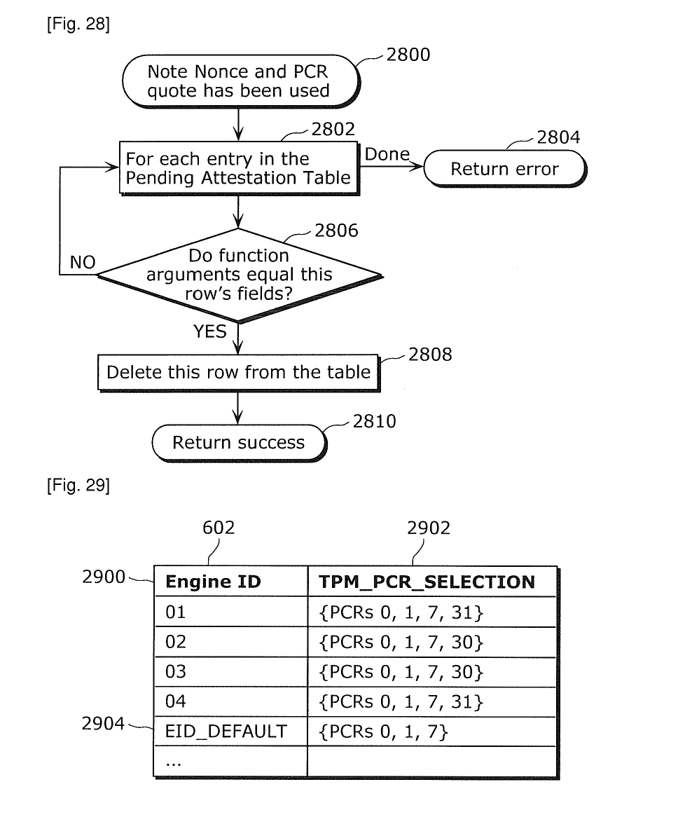

FIG. 28 illustrates noting that a pending remote multi-stakeholder attestation request has been performed. Passed into the routine is the stakeholder nonce and the PCR quote value that has been used 2800. For each row 2802 within the Pending Attestation Table 2600 the stakeholder nonce and PCR quote value passed into the routine are compared 2806 with the corresponding data in the current row of the Pending Attestation Table 2600. If they do match, then the row needs to be marked as used, which in the preferred implementation deletes the current row from the table 2808 and the routine returns successfully to the caller 2810. If no match if found, the next row is checked, and if the end of the table is reached without a match the routine returns with an error to the caller 2804.

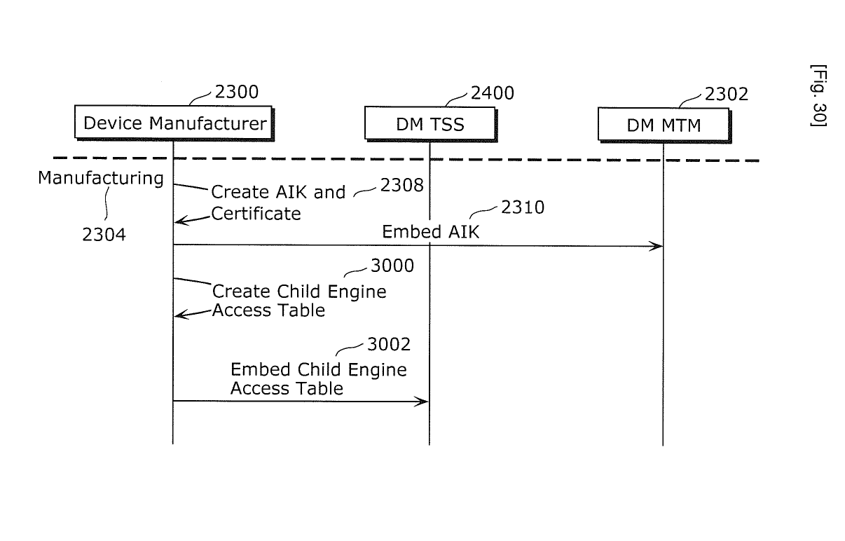

In another preferred embodiment of the system, the Device Manufacturer TSS limits the PCRs it reports back to a challenger when performing a remote multi-stakeholder attestation on a per-stakeholder engine basis. FIG. 29 illustrates the Child Engine PCR Access Table 2900. First, the Engine ID field 602 contains a two character code that describes the stakeholder engine, and the TPM_PCR_SELECTION field 2902 indicates the PCRs within the Device Manufacturer's MTM which a remote multi-stakeholder attestation request is allowed to quote. Within the table there may be a row with an Engine ID field set to EID_DEFAULT 2904, defined to be an Engine ID value that can never occur, and in a preferred embodiment set to the string ‘!!’. This row describes the TPM_PCR_SELECTION 2902 to use if the searched-for Engine ID is not present within the table.

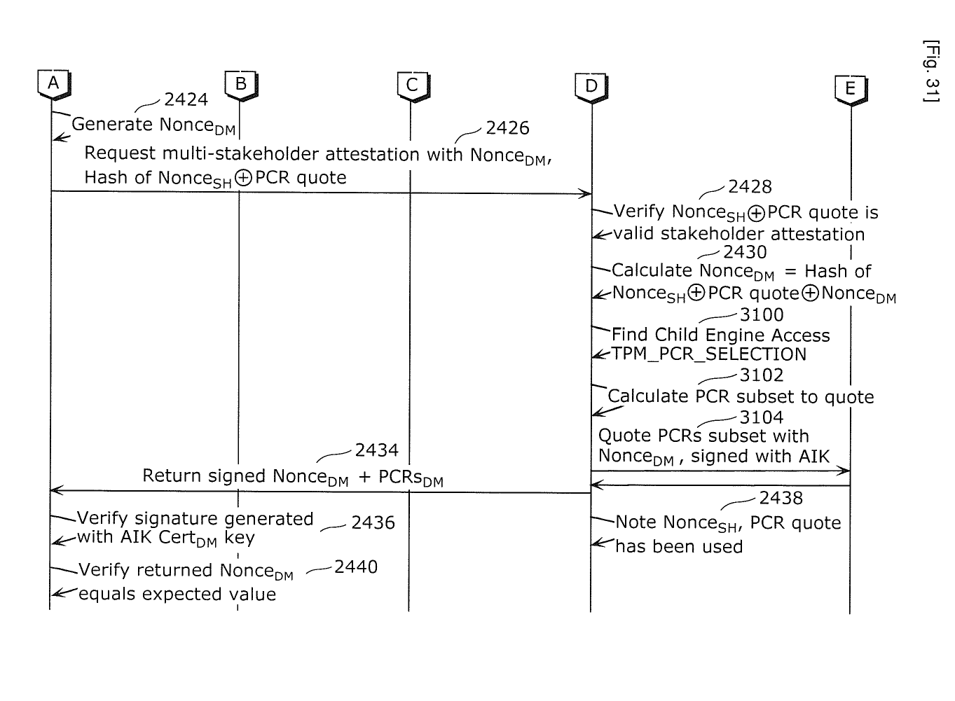

FIG. 30 illustrates a subset of the manufacturing process in preparation for remote multi-stakeholder attestation according to the present invention, focussing on the steps the Device Manufacturer performs in order to limit the PCRs it reports back to a challenger when performing a remote multi-stakeholder attestation. The three actors are an off-device Device Manufacturer server 2300, the Device Manufacturer's TSS on the device 2400 and the Device Manufacturer's MTM on the device 2302. At manufacture time 2304 the Device Manufacturer creates an AIK and a matching certificate 2308 and embeds the private portion of the AIK 2310 within the Device Manufacturer MTM. For hardware MTMs this may be physically writing information into secure memory, and for software MTMs this may be injecting data into an executable and signing it. Next the Device Manufacturer creates the Child Engine Access Table for all the known stakeholder engines that may be present on the device 3000 and chooses which PCRs to allow each to access by assigning desired values to the TPM_PCR_SELECTION field 2902 for each row. This is then embedded 3002 within the Device Manufacturer's TSS. One ordinarily-skilled in the art will see that the table needs to be integrity-protected, and techniques well-known in the art such as cryptographic signatures will suffice for this purpose.

FIG. 31 illustrates a portion of remote multi-stakeholder attestation according to the present invention, where the challenger wishes to confirm the result of a stakeholder attestation with the Device Manufacturer's MTM. This attestation with the stakeholder follows the sequence illustrated in FIG. 24A, so within this embodiment this figure replaces FIG. 24B. As described above, the Challenger 1900 randomly generates a device manufacturer nonce 2424 and sends the nonce and a cryptographic hash of the concatenation of the previously-generated stakeholder nonce 2402 and the resultant PCR quote data 2406 as a remote multi-stakeholder attestation request 2426. In a preferred embodiment, the cryptographic hash routine is SHA1. The Device Manufacturer TSS verifies that this cryptographic hash represents a previously-performed valid stakeholder attestation 2428; the details of this operation are described below. If the verification fails, in a preferred embodiment the Device Manufacturer TSS terminates the attestation session with an appropriate error. Next, the Device Manufacturer TSS calculates a new Device Manufacturer nonce 2430 by evaluating a cryptographic hash of the concatenation of previously-generated stakeholder nonce 2402, the resultant PCR quote data 2406, and the device manufacturer nonce 2424. As described in FIG. 27, during the steps 2428 and 2430 the child stakeholder engine's Engine ID is determined. This Engine ID is used to look up the Engine ID field 602 in the Child Engine Access Table 2900 and the corresponding TPM_PCR_SELECTION field 2902 is retrieved 3100. If the Engine ID is not found, then the EID_DEFAULT row is used instead. If there is no EID_DEFAULT row either, then an empty TPM_PCR_SELECTION is used. Next the PCR subset to quote is evaluated 3102. In a preferred embodiment no processing is necessary as the subset is always just the fields within the relevant row of the Child Engine Access Table, but in an alternative embodiment the Challenger adds a desired TPM_PCR_SELECTION to the attestation request, and by performing a bitwise AND operation between the two TPM_PCR_SELECTION pcrSelect fields disallowed fields are eliminated from the challenger's request. Next, the new nonce and the calculated PCR subset are passed along with a handle to the Device Manufacturer's AIK embedded at manufacturing time to the Device Manufacturer MTM 2302 using the TPM_Quote2 API as described in the prior art to produce a signed quote 3104 of a subset of PCRs within the MTM along with the nonce. This signed new nonce plus PCR quote data is returned 2434 to the Challenger, who can verify the signature using the AIK Certificate previously provisioned by the Device Manufacturer 2436. By also verifying the returned new nonce 2440 by performing the same calculation locally as the Device Manufacturer TSS performed at 2430 the Challenger also has proof that the Stakeholder TSS correctly informed the Device Manufacturer TSS of the nonce the Challenger sent at 2404. Furthermore, since the returned PCR quote information contains a TPM_PCR_INFO_SHORT which itself contains a TPM_PCR_SELECTION, the Challenger can discover which subset of PCRs were actually quoted. Finally, since the Device Manufacturer has successfully completed the remote multi-stakeholder attestation protocol, the Device Manufacturer TSS notes that the stakeholder nonce and PCRs previously recorded at 2414 have been used 2438.

It should be noted that although the present invention is described based on the aforementioned embodiment, the present invention is obviously not limited to such embodiment. The following cases are also included in the present invention.

(1) The aforementioned embodiment follows the requirements of the Mobile Trusted Module and Secure Boot specifications. However, the present invention can be applied to a system containing a Trusted Platform Module and/or supporting Trusted Boot specification as defined by the Trusted Computing Group's TCG Infrastructure Working Group Architecture Part II—Integrity Management Specification Version 1.0.

(2) In the aforementioned embodiment, the attestation is performed in a similar manner to the MTM specifications. However, the present invention can be applied to another attestation system, as long as the attestation system maintains a set of values that represent the state of the system.

(3) Each of the aforementioned apparatuses is, specifically, a computer system including a microprocessor, a ROM, a RAM, a hard disk unit, a display unit, a keyboard, a mouse, and the so on. A computer program is stored in the RAM or hard disk unit. The respective apparatuses achieve their functions through the micro-processor's operation according to the computer program. Here, the computer program is configured by combining plural instruction codes indicating instructions for the computer.

(4) A part or all of the constituent elements constituting the respective apparatuses may be configured from a single System-LSI (Large-Scale Integration). The System-LSI is a super-multi-function LSI manufactured by integrating constituent units on one chip, and is specifically a computer system configured by including a microprocessor, a ROM, a RAM, and so on. A computer program is stored in the RAM. The System-LSI achieves its function through the microprocessor's operation according to the computer program.

Furthermore, each unit of the constituent elements configuring the respective apparatuses may be made as separate individual chips, or as a single chip to include a part or all thereof.

Furthermore, here, System-LSI is mentioned but there are instances where, due to a difference in the degree of integration, the designations IC, LSI, super LSI, and ultra LSI are used.

Furthermore, the means for circuit integration is not limited to an LSI, and implementation with a dedicated circuit or a general-purpose processor is also available. In addition, it is also acceptable to use a Field Programmable Gate Array (FPGA) that is programmable after the LSI has been manufactured, and a reconfigurable processor in which connections and settings of circuit cells within the LSI are reconfigurable.

Furthermore, if integrated circuit technology that replaces LSI appears through progress in semiconductor technology or other derived technology, that technology can naturally be used to carry out integration of the constituent elements. Biotechnology is anticipated to apply.

(5) A part or all of the constituent elements constituting the respective apparatuses may be configured as an IC card which can be attached and detached from the respective apparatuses or as a stand-alone module. The IC card or the module is a computer system configured from a microprocessor, a ROM, a RAM, and the so on. The IC card or the module may also be included in the aforementioned super-multi-function LSI. The IC card or the module achieves its function through the micro-processor's operation according to the computer program. The IC card or the module may also be implemented to be tamper-resistant.

(6) The present invention, may be a computer program for realizing the previously illustrated method, using a computer, and may also be a digital signal including the computer program.

Furthermore, the present invention may also be realized by storing the computer program or the digital signal in a computer readable recording medium such as flexible disc, a hard disk, a CD-ROM, an MO, a DVD, a DVD-ROM, a DVD-RAM, a BD (Blu-ray Disc), and a semiconductor memory. Furthermore, the present invention also includes the digital signal recorded in these recording media.

Furthermore, the present invention may also be realized by the transmission of the aforementioned computer program or digital signal via a telecommunication line, a wireless or wired communication line, a network represented by the Internet, a data broadcast and so on.

The present invention may also be a computer system including a microprocessor and a memory, in which the memory stores the aforementioned computer program and the microprocessor operates according to the computer program.

Furthermore, by transferring the program or the digital signal by recording onto the aforementioned recording media, or by transferring the program or digital signal via the aforementioned network and the like, execution using another independent computer system is also made possible.

(7) Those skilled in the art will readily appreciate that many modifications are possible in the exemplary embodiment without materially departing from the novel teachings and advantages of this invention. Accordingly, arbitrary combination of the aforementioned modifications and embodiment is included within the scope of this invention.

### INDUSTRIAL APPLICABILITY

The present invention can be used in information communication devices and household appliances which update program data, such as a personal computer, a cellular phone, an audio player, a television, and a video recorder.

### REFERENCE SIGNS LIST

100 Mobile device
102 CPU
104 DM MTM
106 Platform Configuration Registers (PCRs)
108 Device hardware
110 Device Manufacturer Engine
112 Roots of Trust
114 Hardware Drivers
116 Device Manufacturer Services
118 DM Checker
120 Failure handler
122 Stakeholder₁ Engine
124, 134 Stakeholder Checker
126 Stakeholder₁ services
128 SH MTM₁
130, 140 Set of PCRs
132 Stakeholder₂ Engine
136 Stakeholder₂ services
138 SH MTM₂
200 Engine Checker
202 Enginer Certs
1900 Challenger
2000 Stakeholder
2300 Device Manufacturer

1-75. (canceled)

76. An information processing system comprising:
a key issuing device comprising a key issuing unit;
a challenger device comprising a challenger unit; and
an attestation device comprising an attestation unit,
wherein:
said key issuing unit is configured to issue an attestation identity key to said attestation device, and issue an attestation encryption key to said challenger device, the attestation encryption key including a public portion and a private portion;
said challenger unit is configured to issue a challenge to said attestation device by transmitting said public portion of said attestation encryption key to said attestation device;
said attestation unit is configured to perform attestation based on said challenge; and
said attestation unit is configured to return, to said challenger device, an attestation result signed with said attestation identity key and encrypted with said public portion of said attestation encryption key, when said attestation encryption key is a key known to said attestation device.

77. The information processing system according to claim 76,
wherein evidence that the attestation encryption key is known to said attestation device comprises a reference to a second attestation encryption key known to said attestation device.

78. The information processing system according to claim 76,
wherein said attestation unit is further configured to validate said public portion of said attestation encryption key.

79. The information processing system according to claim 78,
wherein said key issuing unit is further configured to issue a revocation certificate for said attestation encryption key.

80. The information processing system according to claim 79,
wherein said attestation unit is further configured to invalidate said attestation encryption key on reception of said revocation certificate.

81. The information processing system according to claim 80,
wherein said attestation unit is further configured to validate said public portion of said attestation encryption key's parent key.

82. The information processing system according to claim 81,
wherein said attestation unit is further configured to attest to values of a set of information items that represent the state of said attestation unit.

83. The information processing system according to claim 82,
wherein each item within said set of information items comprises a numeric value describing an aspect of said attestation unit.

84. The information processing system according to claim 83,
wherein each item within said set of information items is a Platform Configuration Register as defined by the Trusted Computing Group.

85. The information processing system according to claim 82,
wherein said challenge issued by said challenger unit further comprises an indicator describing a subset of attestation information to return.

86. The information processing system according to claim 76,
wherein said attestation device further comprises:
a first attestation unit which is said attestation unit;
a second attestation unit configured to respond to a challenge; and
a connector unit configured to allow said first attestation unit to communicate with said second attestation unit,
said challenger unit is configured to issue a challenge to said first attestation unit, using said public portion of said attestation encryption key,
said first attestation unit is configured to perform attestation as a first attestation, based on said challenge,
said first attestation unit is configured to return, to said challenger device, said attestation result as a first attestation result,
said connector unit is configured to communicate the first attestation result from said first attestation unit to said second attestation unit,
said challenger unit is configured to issue a challenge to said second attestation unit,
said second attestation unit is configured to perform second attestation based on said challenge from said challenger unit and said first attestation result communicated through said connector unit, and
said second attestation unit is configured to return a second attestation result to said challenger device.

87. The information processing system according to claim 86,
wherein said second attestation unit is further configured to attest to values of a set of information items that represent the state of said second attestation unit.

88. The information processing system according to claim 87,
wherein each item within said set of information items that represent the state of said second attestation unit comprises a numeric value describing an aspect of said second attestation unit.

89. The information processing system according to claim 88,
wherein each item within said set of information items that represent the state of said second attestation unit is a Platform Configuration Register as defined by the Trusted Computing Group.

90. The information processing system according to claim 89,
wherein said challenge to said second attestation unit issued by said challenger unit further comprises an indicator describing a subset of attestation information to return.

91. The information processing system according to claim 90,
wherein said second attestation unit also comprises an indicator describing a subset of attestation information that said challenger unit is permitted to request.

92. The information processing system according to claim 86,
wherein the communication of said first attestation result further comprises said second attestation unit verifying said communicated first attestation result.

93. The information processing system according to claim 92,
wherein the verification of said communicated first attestation result further comprises said second attestation unit directly accessing said first attestation unit's attestation information.
